(19) United States
(12) Patent Application Publication
(10) Pub. No.: US 2026/0288808 A1
(43) Pub. Date: Sep. 24, 2026

(54) SYSTEM

(71) Applicant: SoftBank Group Corp., Tokyo (JP)

(72) Inventor: Hiroaki KONAKA, Tokyo (JP)

(73) Assignee: SoftBank Group Corp., Tokyo (JP)

(21) Appl. No.: 19/566,990

(22) Filed: Mar. 14, 2026

(30) Foreign Application Priority Data
Mar. 19, 2025 (JP) 2025-045067

(51) Int. Cl. G06F 16/3329; G06F 11/34

(52) U.S. Cl. CPC G06F 16/33295; G06F 11/3409

(57) ABSTRACT

A system includes a processor that is configured to collect, from an internet source or a database, training data related to a specific personality or ideology in order to cause a generative AI model to have the specific personality or ideology, and to perform preprocessing on the collected training data, train the generative AI model by using the preprocessed training data, and input a prompt to the generative AI model to instruct the generative AI model to generate a predetermined response and to cause the generative AI model to generate the response.

### CROSS-REFERENCE TO RELATED APPLICATION

This application is based on and claims priority under 35 USC 119 from Japanese Patent Application No. 2025-045067 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, generative AI models have been increasingly used to provide opinions, recommendations, and explanatory texts in a wide variety of application fields. However, conventional generative AI systems suffer from several issues.

First, conventional generative AI systems do not provide a systematic mechanism for imparting a specific personality or ideology to a generative AI model in a controlled and reproducible manner. As a result, when a user desires opinions or comments from a particular perspective, such as an optimistic personality, a pessimistic personality, an environmentalist ideology, or an economy-focused ideology, the generative AI often produces inconsistent responses that do not stably reflect the intended personality or ideology.

Second, conventional systems generally do not visualize the personality or ideological tendency of a generative AI model in a form that can be easily understood by the user. When the internal tendency of the model is opaque, the user cannot accurately recognize from which standpoint the AI is generating its responses, and therefore the user cannot appropriately interpret or compare the AI's opinions.

Third, conventional opinion-providing systems that rely on human commentators are susceptible to biases based on the notoriety of the speaker, such as fame, social status, or authority, as well as biases derived from the superficial wording of statements. When users evaluate opinions, they may be influenced not only by the content but also by who is speaking and how the statements are phrased, which can distort objective judgment.

Accordingly, there is a need for a system that (i) enables the generative AI model to consistently exhibit a specific personality or ideology through suitable training data collection and preprocessing, (ii) allows the user to grasp and understand the personality or ideology of the generative AI model through visualization, and (iii) reduces bias related to speaker notoriety and wording by utilizing responses generated by a non-human generative AI model.

### SUMMARY

To solve at least part of the above problems, a system according to one aspect of the present invention comprises a processor, wherein the processor is configured to collect training data from an internet source or a database, the training data being related to a specific personality or ideology, and to perform preprocessing on the collected training data in order to cause a generative AI model to have the specific personality or ideology. By systematically collecting and preprocessing data associated with targeted personalities or ideologies, the processor prepares training data that defines characteristic linguistic patterns, attitudes, and viewpoints corresponding to the desired role of the generative AI model.

The processor is further configured to train the generative AI model by using the preprocessed training data. Through this training, the generative AI model is adjusted such that its generated responses statistically reflect the specific personality or ideology encoded in the training data. Consequently, when the generative AI model is later used, the model can generate responses that are consistent with the intended personality or ideology, such as an optimistic personality, a pessimistic personality, an environmentalist ideology, or an economy-focused ideology.

The processor is also configured to input a prompt to the generative AI model to instruct the generative AI model to generate a predetermined response and to cause the generative AI model to generate the response. In this way, the system can produce, on demand, opinion texts or explanatory comments that explicitly reflect the targeted personality or ideology while remaining responsive to the user's specified topic or question.

In addition, according to another aspect, the processor is configured to visualize the personality or ideology of the generative AI model in a form understandable to a user. For example, the processor may output, to a display device, descriptive information summarizing the personality and ideological tendency of the generative AI model, or may present representative example statements that illustrate such tendencies. As a result, the user can easily recognize from which standpoint the generative AI model generates its responses, thereby enabling more informed utilization and comparison of AI-generated opinions.

Furthermore, according to still another aspect, the processor is configured to reduce bias based on at least one of notoriety of a speaker and wording of a statement by using a response generated by the generative AI model that is not a human. By providing opinions through a non-human generative AI model whose identity is independent of fame, social status, or personal attributes, the system suppresses biases arising from the notoriety of human speakers. Additionally, by standardizing or controlling prompts and output formats, the system can diminish the influence of superficial wording, thereby supporting more objective assessment of content by users.

Through these means, the system according to the present invention enables generative AI models to adopt clearly defined personalities or ideologies, presents such tendencies in a user-understandable manner, and reduces biases associated with human speakers and phrasing, thereby improving the reliability, transparency, and fairness of AI-generated opinions and comments.

The term “processor” refers to any hardware or combination of hardware and software that executes instructions to perform data processing operations, including but not limited to a CPU, GPU, microcontroller, ASIC, FPGA, or a distributed computing system.

The term “system” refers to an arrangement comprising at least one processor and, optionally, memory, storage, communication interfaces, and input/output devices, configured to execute the functions described in the claims.

The term “generative AI model” refers to a machine learning model, such as a neural network, that is configured to generate new content, including text, images, audio, or other data, in response to input, based on patterns learned from training data.

The term “training data” refers to data used to adjust parameters of a generative AI model, including text, images, or other information, that encode linguistic patterns, semantic relationships, or behavioral tendencies corresponding to a specific personality or ideology.

The term “personality” refers to a consistent set of characteristic tendencies in expression, attitude, or tone, such as optimism, pessimism, friendliness, caution, or similar traits, which are reflected in the generated responses of the generative AI model.

The term “ideology” refers to a coherent set of beliefs, values, or viewpoints regarding social, political, economic, or environmental issues, such as environmentalism or economic growth orientation, which influence the content and stance of the generative AI model's responses.

The term “internet source” refers to any server, website, online repository, or network-accessible service from which data can be obtained via a network such as the Internet.

The term “database” refers to any structured or semi-structured data storage system, including relational databases, NoSQL databases, data warehouses, or similar systems, from which data can be queried and retrieved.

The term “collect” refers to acquiring data from at least one source, such as an internet source or a database, by downloading, querying, accessing, or otherwise obtaining the data for subsequent processing.

The term “preprocessing” refers to operations performed on collected data before training of the generative AI model, including but not limited to cleaning, normalizing, tokenizing, filtering, labeling, or formatting the data.

The term “train” refers to adjusting parameters of the generative AI model, by applying machine learning algorithms to preprocessed training data, so that the model's output statistically reflects patterns contained in the training data.

The term “prompt” refers to input information provided to the generative AI model, including instructions, contextual text, or queries, that guide or constrain the model in generating a response.

The term “response” refers to output generated by the generative AI model in reaction to a prompt, including but not limited to text, statements, opinions, or explanations.

The term “predetermined response” refers to a response that is generated by the generative AI model in accordance with at least one predetermined condition, such as a specified topic, format, style, personality, or ideological stance.

The term “visualize” refers to presenting information in a form perceivable by a user, such as text, graphics, charts, icons, or other visual elements, via a display or other output device.

The term “personality or ideology of the generative AI model” refers to the characteristic tendencies, styles, or viewpoints that the generative AI model exhibits in its responses as a result of training with specific training data.

The term “form understandable to a user” refers to a representation, such as summarized text, labels, examples, or graphical indicators, that enables an ordinary user to recognize and comprehend the personality or ideological tendency of the generative AI model without requiring technical knowledge of internal model parameters.

The term “bias” refers to systematic influence or distortion in the evaluation or perception of a response that is caused by non-substantive factors, such as who the speaker is or how the statement is phrased, rather than by the actual content of the response.

The term “notoriety of a speaker” refers to attributes of a human speaker, such as fame, popularity, authority, social status, or reputation, that may influence how a listener subjectively evaluates the speaker's statements.

The term “wording of a statement” refers to the specific choice of words, expressions, or rhetorical style used to express content, independent of the underlying factual or logical substance of the statement.

The term “a response generated by the generative AI model that is not a human” refers to a response that is produced automatically by the generative AI model, where the model itself is not a human being and does not possess human identity, fame, or personal attributes.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

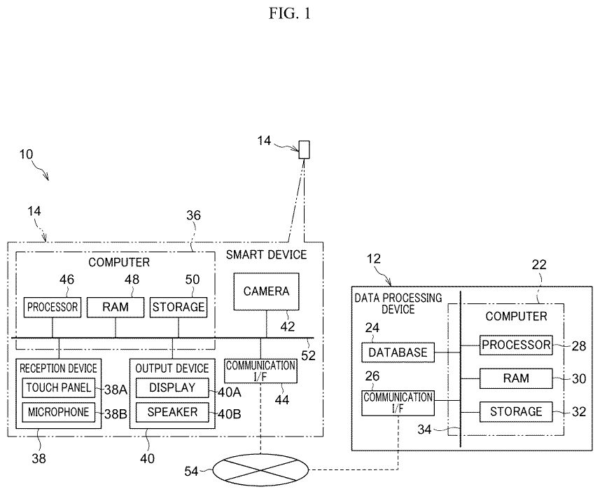

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

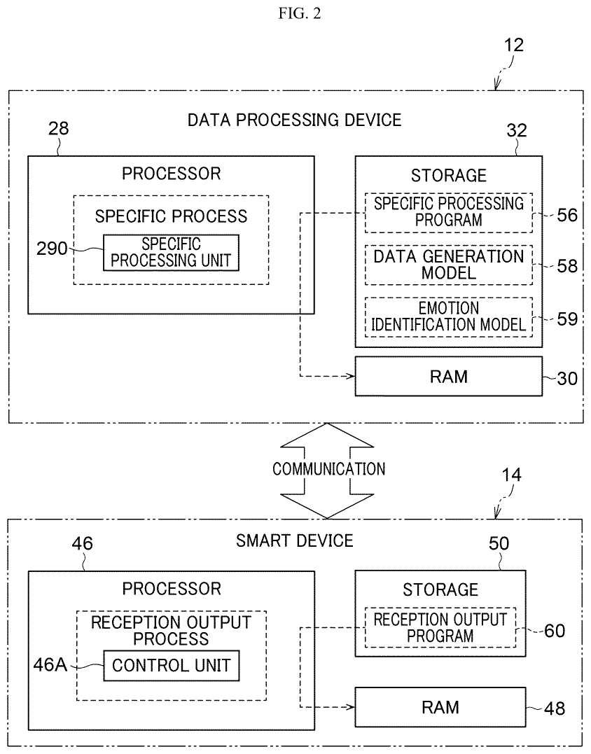

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional generative AI models are typically trained on broad, heterogeneous corpora without systematic control over higher-level attributes such as personality, stance, or ideology. As a result, these models often produce responses whose tone and viewpoint are unstable, weakly aligned with user expectations, and difficult to interpret or explain. Furthermore, when developers attempt to tune such models for specific attributes, they generally rely on ad hoc prompt engineering or small, manually curated datasets, which do not provide robust control over the model's behavior and are not scalable across many different attributes.

From a computer-technology perspective, existing systems lack an integrated architecture and processing pipeline that (i) acquires and structures training information in a manner directly conditioned on desired attributes, (ii) fine-tunes generative AI models through coordinated preprocessing, encoding, and learning control operations executed across server and terminal resources, and (iii) manages multiple attribute-imparted models and their associated training and configuration information so that a computing system can reliably generate multifaceted responses to a given prompt sentence. In particular, conventional systems do not provide systematic mechanisms for (a) selecting and organizing attribute-related training information from external sources at scale, (b) enforcing consistent tokenization and encoding across training and inference, (c) evaluating and selecting trained models based on explicit performance metrics, and (d) orchestrating multi-model inference to present multiple, attribute-differentiated responses to a single user input.

Moreover, generative AI models trained on human-authored data may inherit unintended biases arising from attributes of information sources such as popularity, author identity, or superficial textual features. Conventional approaches do not provide explicit controls in the training and output-generation stages to suppress weighting based on such source attributes, resulting in responses that may overrepresent certain viewpoints and underrepresent others in ways that are not technically justified. This impairs the reliability, fairness, and transparency of the computer-implemented generation process.

There is therefore a need for an improved computer-implemented system that provides a structured, attribute-aware training and inference pipeline for generative AI models. The system should enable a processor to: automatically acquire and preprocess training information corresponding to predetermined attributes from external information sources; encode such information into code sequences suitable for machine learning; perform controlled learning operations using backpropagation and optimization algorithms to generate attribute-imparted generative AI models; manage multiple models and their associated information in an organized manner; generate and present multifaceted response information for a given prompt sentence; and reduce bias in generated responses by suppressing dependence on source-specific attributes during training and output control. By addressing these needs, the invention aims to improve the functioning of computer systems that implement generative AI models, rather than merely automating a mental process or abstract idea.

The specific processing by the specific processing unit 290 of the data processing device 12 in Example 1 is realized by the following means.

The present invention provides a server comprising a processor configured to acquire, from external information sources, training information related to predetermined attributes, perform machine-executable preprocessing operations on the training information including removal of unnecessary information and conversion of text into code sequences using a tokenizer, and convert the preprocessed training information into a storage format usable for machine learning; to cause, by transmitting configuration information and the preprocessed training information to an information processing terminal having computational resources, execution of a learning process of a generative AI model on the terminal, the learning process including forward computation, backpropagation computation, and optimization computation based on a loss function so as to update an internal state of the generative AI model and thereby generate an attribute-imparted generative AI model; to manage, in an associated storage, multiple attribute-imparted generative AI models together with corresponding training information and setting information, and to select one or more attribute-imparted generative AI models in response to a prompt sentence; and to control generation and output of response information by encoding the prompt sentence into a code sequence, inputting the code sequence into the selected attribute-imparted generative AI model or models, obtaining sequential output code sequences, decoding the output code sequences into natural-language response information, and presenting multifaceted response information by combining responses from a plurality of attribute-imparted generative AI models, while suppressing weighting based on source-specific attribute information in the training information so as to reduce bias in the generated responses, and while calculating performance metrics using verification information to select and record models that satisfy predetermined conditions as operation models. This enables a technical improvement in computer functionality by providing an integrated, attribute-aware training and inference pipeline that systematically controls data acquisition, encoding, learning, model selection, and multi-model response generation for generative AI models, thereby allowing a computer system to generate stable, interpretable, and less biased responses aligned with specified attributes in response to user prompt sentences.

The term “generative AI model” refers to an information processing model, typically implemented as a parameterized machine learning model such as a neural network, that is configured to generate output information including text in response to input information by predicting subsequent elements in a sequence.

The term “attribute” refers to a higher-level characteristic, such as a style, tone, personality, stance, viewpoint, or ideology, that is intended to be reflected in outputs generated by a generative AI model.

The term “attribute-imparted generative AI model” refers to a generative AI model whose internal state has been adjusted by a learning process using attribute-related training information so that outputs generated by the model statistically reflect a predetermined attribute.

The term “training information” refers to digital information, including text data and optionally associated metadata, that is used as input for a learning process to adjust parameters of a generative AI model so as to impart a predetermined attribute.

The term “external information source” refers to an information providing resource, such as a communication network, a remote storage system, or a remote database system, from which training information related to a predetermined attribute can be acquired.

The term “preprocessing” refers to a sequence of machine-executable operations applied to training information, including at least removal of unnecessary information and conversion of text into code sequences, to prepare the training information for use in a learning process.

The term “unnecessary information” refers to portions of training information, such as markup elements, control characters, non-content symbols, or irrelevant segments, that do not contribute to imparting the predetermined attribute to the generative AI model and are removed during preprocessing.

The term “code sequence” refers to a sequence of digital codes, including token identifiers, numeric vectors, or other encoded representations, obtained by converting natural language information or other input information using an encoding procedure suitable for processing by a generative AI model.

The term “storage format” refers to a data organization structure, such as a file format or record schema, in which preprocessed training information is stored so that it can be efficiently accessed and used by a learning process.

The term “encoding unit” refers to a functional component, implemented in software, hardware, or a combination thereof, that converts input information including prompt sentences and training information into code sequences compatible with a generative AI model.

The term “learning process” refers to a computational procedure executed by an information processing device, including repeated forward computation, backpropagation computation, and optimization computation based on a loss function, to update internal parameters of a generative AI model using training information.

The term “forward computation” refers to a processing operation in which input code sequences are propagated through layers of a generative AI model to compute output values such as predicted token distributions.

The term “backpropagation computation” refers to a processing operation in which gradients of a loss function with respect to parameters of a generative AI model are computed by propagating error information backward through the model.

The term “optimization computation” refers to a processing operation that updates parameters of a generative AI model based on gradients, using an optimization algorithm such as gradient descent, so as to reduce the loss function.

The term “internal state of the generative AI model” refers to values stored in the model, including at least trainable parameters such as weights and biases, and optionally auxiliary variables used by an optimization algorithm.

The term “configuration information” refers to control information specifying conditions of a learning process or inference process, including at least hyperparameters, file locations, model selection identifiers, and attribute definitions.

The term “information processing terminal” refers to an information processing device, such as a computing device with a processor and memory, that has computational resources sufficient to execute a learning process or inference process of a generative AI model.

The term “prompt sentence” refers to input information, typically natural language text, provided by a user or another process to condition or direct generation of output information by a generative AI model.

The term “response information” refers to output information, typically natural language text, that is generated by a generative AI model in response to a prompt sentence.

The term “multifaceted response information” refers to a set of response information items that are generated for a common prompt sentence by a plurality of attribute-imparted generative AI models, and that reflect different attributes or viewpoints.

The term “verification information” refers to information distinct from training information, used to evaluate performance of a generative AI model by computing one or more performance metrics without updating model parameters.

The term “performance metric” refers to a quantitative indicator, such as loss value, accuracy, perplexity, or another measurement, used to evaluate the performance of a generative AI model on verification information.

The term “operation model” refers to an attribute-imparted generative AI model that has been selected based on one or more performance metrics satisfying predetermined conditions, and that is designated for use in an operational inference environment.

The term “source-specific attribute information” refers to information related to characteristics of an information source, such as popularity, identity of an author, or external reputation indicators, which is not directly required for representing content related to a predetermined attribute.

The term “output control processing” refers to processing operations performed during or after generation of output information by a generative AI model, including selection, filtering, reweighting, or modification of generated outputs to satisfy desired constraints such as bias reduction.

The term “bias” refers to a systematic distortion or imbalance in response information, arising from unintended overemphasis or underemphasis of certain patterns or viewpoints due to characteristics of training information or the learning process, and not necessarily corresponding to a desired predetermined attribute.

In one embodiment, a server cooperates with one or more terminals and with a user-operated client application to implement an attribute-imparted generative AI model. The server, the terminal, and the user-side device are interconnected via a communication network such as the Internet or a local area network.

The server includes at least one processor, a main memory, a persistent storage device, and a communication interface. The server executes an operating system such as a general-purpose server operating system and middleware including a database management system and a web server. The server executes application programs that implement data acquisition, preprocessing, configuration management, and orchestration of training and inference for the generative AI model.

The terminal includes at least one processor, a main memory, a persistent storage device, and, in some embodiments, a graphics processing unit or another hardware accelerator. The terminal executes an operating system and a machine learning framework such as a neural network framework library. The terminal executes application programs that implement model loading, learning control, inference, and evaluation.

The user operates a user device, such as a personal computer or a mobile terminal, that executes a web browser or a dedicated client application. The user device communicates with the server and/or the terminal via a network interface. The user inputs natural language prompt sentences into an input field of a graphical user interface.

In one example configuration, the server uses a neural network framework library, a tokenization library, and a text-processing library to implement preprocessing and data management. The terminal uses a machine learning framework library, such as a tensor-based numerical computation library, and a model-management library for loading and saving generative AI models.

The server prepares a program that defines data-processing pipelines and learning configurations for one or more generative AI models. The server stores the program and associated configuration information in a storage system, such as a relational database or a distributed file system. The server specifies hyperparameters such as learning rate, batch size, sequence length, number of training epochs, optimizer type, and regularization settings. The server further defines attribute identifiers (for example, an identifier for an “optimistic” attribute and an identifier for an “environmentalist” attribute) and associates each identifier with a set of training information sources and configuration parameters.

The server uses network communication software to access external information sources, such as web servers and remote databases. The server sends HTTP requests and database queries to obtain digital text data related to predetermined attributes. For example, when the server prepares training information for an optimistic attribute, the server acquires texts that exhibit optimistic tone, such as positive commentaries and encouraging messages. When the server prepares training information for an environmentalist attribute, the server acquires texts describing environmental protection, sustainability, and ecological concerns.

The server performs machine-executable preprocessing operations on the acquired text data. The server removes markup elements such as HTML tags, scripts, and style information by applying string-processing algorithms and regular expressions. The server normalizes character encodings and converts all text to a unified encoding format. The server divides text into sentence units by applying sentence-boundary detection algorithms. The server then applies a tokenizer, which may implement a subword segmentation algorithm such as byte-pair encoding or a similar scheme, to convert character sequences into token identifiers. The tokenizer consults a vocabulary stored in a data structure and maps substrings of the input text to integer codes. The server discards tokens or sentences that do not satisfy length or content criteria and labels each resulting sequence with the corresponding attribute identifier.

The server converts the preprocessed and tokenized data into a structured storage format. In one embodiment, the server stores sequences of token identifiers, attention masks, and attribute identifiers in records within a file or in database tables. Each record may include fields for an input sequence, a target sequence, a sequence length, and attribute metadata. The server may compress or shard data files to improve throughput when the terminal reads the data.

The server transmits the preprocessed training data and configuration information to the terminal by using a secure communication protocol. The server may send uniform resource locators pointing to data files, along with checksums and metadata, so that the terminal can verify data integrity. The server also transmits a program that defines the architecture of the generative AI model and the learning procedure.

The terminal receives the program, the data references, and the configuration information from the server. The terminal installs required software components if they are not already present. The terminal loads a base generative AI model, which, in one embodiment, is a neural network with a transformer architecture. Such a model comprises an embedding layer, multiple self-attention layers, feed-forward layers, normalization layers, and an output layer that maps internal state vectors to token-probability distributions. The terminal loads the corresponding tokenizer configuration to ensure that the same code sequences used in preprocessing are used during learning and inference.

The terminal uses a machine learning framework to allocate data structures for model parameters, gradients, and optimizer states. The terminal configures a computational graph that defines operations for embedding lookup, self-attention, matrix multiplications, activation functions, normalization, and output projection. The terminal allocates these structures to a processor and, if available, to a hardware accelerator such as a graphics processing unit. The terminal sets computation modes such as mixed-precision arithmetic in order to improve throughput and reduce memory usage.

The terminal executes a learning procedure that adjusts the internal state of the generative AI model. The terminal reads batches of tokenized sequences from the storage format, using an input pipeline that buffers and prefetches data to minimize I/O latency. The terminal passes input sequences through the embedding layer and the stacked self-attention and feed-forward layers. At each step, the terminal computes an output distribution over possible next tokens. The terminal computes a loss function such as cross-entropy between predicted token distributions and actual target tokens. The terminal then computes gradients of the loss function with respect to model parameters via automatic differentiation mechanisms implemented in the machine learning framework. The terminal applies an optimization algorithm such as a variant of stochastic gradient descent, where the terminal updates parameters by combining current gradient values with historical gradient statistics and learning-rate schedules.

The terminal repeats this procedure over multiple epochs, where an epoch corresponds to a complete pass through the training dataset. The terminal may apply additional techniques such as learning-rate warmup, gradient clipping, and weight decay in order to stabilize training and improve generalization. The terminal records metrics such as training loss, validation loss, and perplexity at regular intervals and sends summaries back to the server. The terminal stores intermediate checkpoints of the generative AI model by writing parameter tensors and optimizer states to non-volatile memory.

The terminal also executes an evaluation procedure using verification information distinct from the training information. The terminal computes performance metrics such as loss, perplexity, and response diversity measures for each attribute-imparted generative AI model. The terminal may perform automatic tests where the terminal generates responses to evaluation prompt sentences and compares them against reference outputs or target distributions. Based on these metrics, the terminal notifies the server of which checkpoint satisfies predetermined-quality thresholds.

The server receives evaluation results from the terminal and selects one or more operation models. The server records references to the selected models in a model registry stored in a database. The server associates each operation model with its attribute identifier, tokenizer configuration, and version number. The server may update an inference-service configuration so that subsequent user requests are routed to the correct operation models.

The terminal deploys selected operation models as services. The terminal loads the attribute-imparted generative AI models into memory and sets them to an inference mode, in which the terminal disables gradient computation. The terminal instantiates a request handler that receives prompt sentences and attribute-selection data from client applications. The terminal uses the tokenizer to convert a received prompt sentence into a code sequence, then performs autoregressive generation by repeated application of the transformer layers. The terminal can employ different decoding strategies, such as greedy decoding, beam search, or stochastic sampling based on probability distributions, each implemented by explicit algorithms that maintain and update candidate sequences.

The user interacts with the system through a user interface provided by the server or the terminal. The user selects a desired attribute model, such as an optimistic model or an environmentalist model. The user enters a prompt sentence such as “The weather is terrible today. How should I look at it?” or “I want to travel abroad, but I also care about the environment. Do you have any suggestions?”. The user submits the prompt sentence via the interface, which sends a request to the terminal.

The terminal receives the request, identifies the indicated attribute-imparted generative AI model, and generates a response. For example, when the user selects the optimistic model and enters “The weather is terrible today. How should I look at it?”, the terminal may generate a response such as “Even on a rainy day, you can discover small pleasures indoors or enjoy the fresh air after the rain.” When the user selects the environmentalist model and enters “I want to travel abroad, but I also care about the environment. Do you have any suggestions?”, the terminal may generate a response such as “You may consider choosing destinations reachable by rail or offsetting flight emissions, and selecting accommodations that follow sustainable practices.”

The server can orchestrate multi-model responses by requesting inference from multiple attribute-imparted generative AI models for the same prompt sentence. The server aggregates the different responses and returns them to the user as multifaceted response information. This arrangement allows the system to provide diverse viewpoints in a structured way while sharing infrastructure for tokenization, model management, and communication.

From a technical perspective, the server and the terminal cooperate to improve computer functionality in several ways. The server structures training information according to explicit attribute identifiers and stores it in optimized data formats. This improves data locality and reduces random access overhead during learning. The terminal employs batched processing on a hardware accelerator, using a transformer architecture with shared computations across tokens in a sequence, which enables significant throughput improvements compared with sequential, non-batched text generation. The use of consistent tokenization and attribute-aware data labeling reduces ambiguity in input representation and improves convergence properties of the learning algorithm, thereby lowering the number of training iterations required to reach a given performance.

The server implements management of multiple attribute-imparted generative AI models and their associated configuration information. This enables efficient model selection and switching at inference time without reloading large parameter sets, thereby reducing response latency and network transmissions. Because the server stores training information and model metadata in a structured registry, it can reuse shared base models and avoid redundant downloads or training, which reduces storage usage and communication load.

The terminal uses automatic differentiation and optimized numerical kernels within the machine learning framework to compute gradients and parameter updates efficiently. This processing is not a mere automation of human mental activity; it relies on matrix multiplications, vectorized operations, and parallel computation across multiple processing units, which humans cannot perform in a comparable manner. In addition, the system applies nontrivial control logic, such as adaptive learning-rate schedules, gradient clipping thresholds, and model-selection criteria based on performance metrics. These mechanisms combine to reduce overfitting and improve the robustness of the generative AI models.

The system also introduces bias-control mechanisms. The server, during preprocessing, may remove or anonymize metadata fields related to source identity, textual markers of popularity, or other source-specific attribute information. The terminal, during training, may adjust loss weighting or sampling strategies to avoid over-representing frequently occurring sources. By altering data structures and learning procedures in this manner, the system reduces the influence of source-specific attributes and produces more balanced response information. This yields technical benefits such as lower variance in model outputs and improved fairness properties, which can be quantified by measuring distributional differences across subsets of evaluation data.

The system can be implemented in several variations. In another embodiment, the server and the terminal reside on the same physical machine, and the system optimizes memory sharing between preprocessing modules and training modules to avoid redundant copies of tokenized sequences. In yet another embodiment, the system uses multiple terminals, each with its own hardware accelerator, and the server distributes training tasks over these terminals using a parallel training strategy. Each terminal trains a subset of the attribute-imparted generative AI models, and the server collects evaluation metrics from each terminal to make global model-selection decisions.

In a further embodiment, the server applies data-augmentation techniques to the training information, such as paraphrasing or synonym replacement under attribute consistency constraints. The server generates additional token sequences that preserve target attributes while diversifying linguistic realization. The terminal then learns from this augmented dataset, which improves the generative AI model's robustness and reduces sensitivity to specific phrasings.

In another variation, the server uses a different generative AI model architecture, such as a recurrent neural network with attention mechanisms. The terminal still uses the same basic learning process forward computation, backpropagation, and optimization but the internal structure of the generative AI model differs. The server can adjust configuration information accordingly to set the number of layers, hidden-state dimensionality, and context window size.

Because the server and the terminal are configured to perform these specific data-structuring, learning, bias-control, and model-management operations, the system improves the technical performance of computer-based natural-language generation. The arrangement leads to faster training, more efficient inference, better utilization of hardware resources, and more reliable control of generated content attributes compared with conventional systems that treat the generative AI model as a black box trained on undifferentiated data.

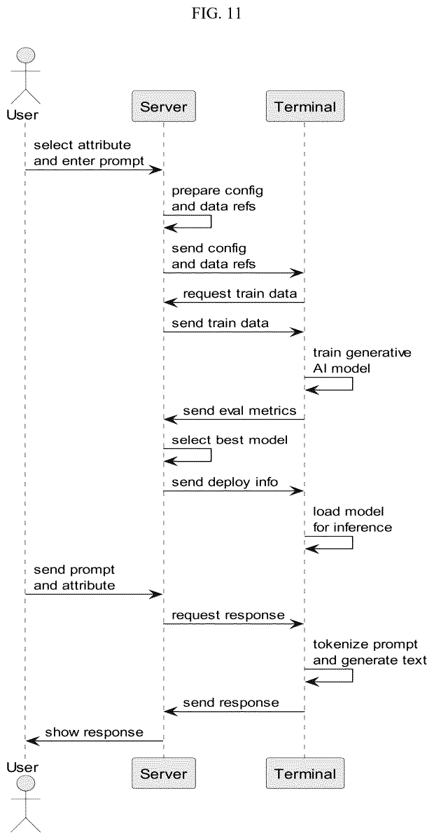

The following describes the processing flow using FIG. 11.

### Step 1

The server acquires raw text data related to predetermined attributes from external information sources.

The server receives as input attribute specifications, such as an identifier for an optimistic attribute or an environmentalist attribute, and a set of source definitions including network locations and query conditions. The server sends HTTP requests and database queries to remote servers and databases, receives digital text documents as responses, and stores the raw text into storage devices as unstructured records. The server filters the documents by applying keyword matching and length thresholds, and outputs a collection of raw text records labeled with corresponding attribute identifiers.

### Step 2

The server preprocesses the acquired raw text to generate cleaned and segmented text data.

The server receives as input the collection of raw text records and associated attribute identifiers from Step 1. The server applies text-cleaning operations, such as removal of markup tags, control characters, and redundant whitespace, and performs normalization of character encoding. The server then executes sentence-boundary detection to split long texts into individual sentences, and discards sentences that are too short or irrelevant. The server performs these data transformations to improve the quality and consistency of the textual content and outputs a set of cleaned sentence-level text records, each associated with an attribute identifier.

### Step 3

The server tokenizes the cleaned sentences and converts them into structured training records.

The server receives as input the cleaned sentence-level text records from Step 2. The server uses a tokenizer implementing a subword segmentation algorithm and a predefined vocabulary to convert each sentence into a sequence of token identifiers. The server generates additional data structures, such as attention masks and sequence-length values, and packs these into records that include input token sequences, target token sequences, attribute identifiers, and metadata. The server stores these structured records in a storage format such as files or database tables and outputs a set of training datasets ready for learning.

### Step 4

The server generates and transmits configuration and control information for model training.

The server receives as input system-level settings and attribute-related requirements from an administrator or from a configuration file. The server creates configuration objects specifying model architecture parameters, learning-rate schedules, batch sizes, numbers of epochs, optimizer types, and paths to the structured training datasets from Step 3. The server serializes these configuration objects and transmits them, together with references to the training datasets, to the terminal via a communication interface. The server outputs a package containing configuration information and dataset locations for each attribute.

### Step 5

The terminal initializes a base generative AI model and associated tokenizer.

The terminal receives as input the configuration package and dataset locations from Step 4. The terminal loads a base generative AI model, for example a transformer-based neural network, from persistent storage into main memory. The terminal loads the corresponding tokenizer configuration so that tokenization during training and inference is consistent with preprocessing on the server. The terminal allocates memory for model parameters, intermediate activations, and optimizer states, and maps these data structures to a processor and, if available, a hardware accelerator. The terminal outputs an initialized model instance and tokenizer instance that are ready for training.

### Step 6

The terminal constructs data-loading pipelines for the training datasets.

The terminal receives as input the dataset locations and attribute identifiers from Step 4. The terminal opens the structured training files or database tables and implements an input pipeline that reads records into memory in mini-batches. The terminal shuffles records, pads sequences in a batch to a uniform length, and forms tensors for input token sequences, target token sequences, attention masks, and attribute identifiers. The terminal outputs batches of training tensors that are suitable as input to the generative AI model.

### Step 7

The terminal performs a learning process to generate attribute-imparted generative AI models.

The terminal receives as input the initialized generative AI model and tokenizer from Step 5 and the training batches from Step 6. For each batch, the terminal feeds the input token sequences into the embedding layer and stacked transformer layers, computes predicted token distributions at each position, and calculates a loss value, such as cross-entropy, between the predictions and the target token sequences. The terminal uses automatic differentiation to compute gradients of the loss with respect to the model parameters, and applies an optimizer to update the parameters. By repeating these computations for multiple epochs, the terminal adjusts the internal weights of the model so that output distributions reflect the patterns present in attribute-labeled training data. The terminal outputs trained attribute-imparted generative AI models for each targeted attribute, together with learned parameter sets and training logs.

### Step 8

The terminal evaluates the trained generative AI models using verification data.

The terminal receives as input the trained attribute-imparted generative AI models from Step 7 and verification datasets derived from the server's training pipeline. The terminal switches each model to evaluation mode, disables gradient computation, and runs inference on the verification token sequences. The terminal calculates performance metrics such as validation loss and perplexity for each attribute-imparted model by aggregating loss values across verification batches. The terminal compares the metrics against predetermined thresholds and outputs evaluation results, including metric values and candidate model checkpoints that satisfy quality criteria.

### Step 9

The server selects operation models based on the evaluation results.

The server receives as input the evaluation results and candidate model checkpoints from Step 8. The server compares performance metrics across checkpoints for each attribute and applies selection rules, such as choosing the checkpoint with minimum validation loss subject to stability constraints. The server records references to the selected checkpoints, tokenizer versions, and attribute identifiers in a model registry. The server outputs a set of operation models designated for inference, along with their associated metadata.

### Step 10

The terminal deploys selected operation models as inference services.

The terminal receives as input the list of operation models and associated metadata from Step 9. The terminal loads the corresponding model parameter files and tokenizer configurations into memory and initializes an inference server process. The terminal binds communication endpoints, such as network sockets or local interfaces, and registers handlers that accept prompt sentences and attribute-selection information from client requests. The terminal outputs a running inference service capable of generating responses for multiple attribute-imparted generative AI models.

### Step 11

The user provides a prompt sentence and selects a target attribute model.

The user receives as input a graphical interface from a client application connected to the terminal or the server. The user selects one or more attribute options, such as an optimistic or an environmentalist attribute, via interface elements, and enters a natural-language prompt sentence, such as “The weather is terrible today. How should I look at it?” or “I want to travel abroad, but I also care about the environment. Do you have any suggestions?”. The user then submits the input; the client application sends a request containing the prompt sentence and the selected attribute information to the inference service. The user outputs, from the client side, a structured request ready for processing by the terminal.

### Step 12

The terminal generates response information from the selected attribute-imparted generative AI model.

The terminal receives as input the request containing the prompt sentence and attribute-selection information from Step 11. The terminal uses the tokenizer to convert the prompt sentence into a token sequence, and passes this sequence to the selected attribute-imparted generative AI model. The terminal executes autoregressive generation, where it repeatedly computes next-token probability distributions, selects tokens according to a decoding strategy (for example greedy decoding or sampling), and appends them to the output sequence until an end condition is reached. The terminal then uses the tokenizer to decode the generated token sequence back into natural-language text. The terminal outputs the generated response information corresponding to the specified attribute.

### Step 13

The server or the terminal presents multifaceted response information when multiple attribute models are selected.

The server or the terminal receives as input the prompt sentence and a set of selected attributes from Step 11. The server or the terminal requests inference from multiple attribute-imparted generative AI models, each receiving the same tokenized prompt sentence. The server or the terminal collects the generated responses, assembles them into a combined representation that associates each response with its attribute identifier, and formats the combined content for display. The server or the terminal outputs multifaceted response information, such as an optimistic response and an environmentalist response shown side by side, and returns this formatted output to the user's client application.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented advertising systems typically perform personalization by matching predefined audience segments to static message templates using simple rule engines or basic machine learning models. In such systems, a server generally selects, from a limited set of pre-authored messages, an advertisement that most closely corresponds to coarse-grained user attributes such as age group, geographic region, or product category interest. As a result, the generated output often fails to reflect nuanced user characteristics, such as an individual user's underlying values, ideology, or preferred tone of communication.

Moreover, in conventional architectures, behavior logs collected from user terminals are primarily used for statistical reporting or basic targeting, but they are not deeply integrated into the internal control logic of a generative AI model. In particular, conventional systems do not dynamically translate continuously updated user behavior and feedback into structured “role information” and rich prompt sentences that control a generative AI model at inference time. Consequently, even when a generative AI model is employed, it is typically used in a generic manner, without systematic adaptation of the model's persona or speaking style to the evolving preferences and reactions of individual users.

Further, existing systems are limited in their ability to manage multiple personas or viewpoints in a coordinated fashion. Although multiple models or configurations may exist, conventional frameworks do not provide a unified mechanism by which a processor can (i) associate user-specific interest attributes and value attributes with plural role definitions, (ii) generate multiple candidate advertising messages through different role settings of a generative AI model, and (iii) algorithmically select an optimal message based on explicit conditions. This limitation reduces the system's capability to efficiently explore and exploit different messaging strategies and leads to suboptimal use of computational resources and model capacity.

Additionally, feedback loops in known systems are often shallow. User responses such as clicks, dwell time, purchases, or free-text comments are generally used only for coarse conversion metrics or offline analysis. These feedback signals are rarely converted into machine-interpretable updates of user-level interest attributes and value attributes that directly affect prompt construction for subsequent generative AI inference. As a result, the system cannot effectively refine its personalization over time at a fine granularity, and system-level performance, such as relevance, user engagement, and overall efficiency of ad delivery, remains limited.

There is therefore a need for an improved computer-implemented system and method in which a processor: (i) systematically stores and analyzes user behavior information to infer structured interest attributes and value attributes; (ii) maintains multiple role definitions that describe different personality attributes and ideology attributes for a generative AI model; (iii) automatically constructs prompt sentences that embed both role information and user-specific attributes; (iv) orchestrates one or more generative AI models to generate and evaluate multiple advertising message candidates; and (v) updates user-level attributes using both behavioral data and free-text feedback so that future prompt sentences and generated content are adaptively optimized. Such a system would improve the overall operation of computer-based advertising platforms by making the content generation pipeline more responsive, fine-grained, and computationally effective.

The specific processing by the specific processing unit 290 of the data processing device 12 in Application Example 1 is realized by the following means.

The present invention provides a server comprising a processor configured to store, in a storage device, behavior information obtained from user terminals, and to estimate, based on the stored behavior information, an interest attribute and a value attribute for each user; to store, in an information storage structure, a plurality of types of role information associated with the interest attribute and the value attribute, to generate, for each user, a prompt sentence including one or more items of the role information together with advertising target information and style condition information, and to input the generated prompt sentence to a generative AI model so as to cause the generative AI model to generate advertising message information; to transmit the advertising message information to the corresponding user terminal and to control display of the advertising message information on the user terminal; to acquire response information and opinion information from the user terminal with respect to the displayed advertising message information, to update the interest attribute and the value attribute on the basis of the acquired response information and opinion information, and to change content of a subsequent prompt sentence on the basis of the updated interest attribute and value attribute; and to use, as the generative AI model, a plurality of models having different role information or a single model to which different role information settings are applied, to input one or more prompt sentences to each of the models so as to cause generation of a plurality of pieces of advertising message information, and to select at least one of the plurality of pieces of advertising message information on the basis of a predetermined condition. This enables the server to improve computer operation by automatically transforming low-level behavior logs and user feedback into structured user attributes and role-conditioned prompt sentences, by dynamically controlling one or more generative AI models to generate and select advertising messages that are closely aligned with individual user characteristics, and by continuously refining subsequent prompt sentences based on quantified response information, thereby enhancing personalization accuracy, system adaptability, and overall efficiency of computer-implemented advertising delivery.

The term “behavior information” refers to information indicating actions performed by a user in relation to digital content or services, including at least one of viewing operations, selection operations, purchase operations, navigation operations, and temporal usage patterns, which is obtained from a user terminal.

The term “storage device” refers to a hardware or virtualized component configured to store digital data, including but not limited to magnetic storage, semiconductor storage, optical storage, or network-based storage.

The term “interest attribute” refers to structured data representing a degree or type of a user's interest in one or more topics, categories, or themes, which is inferred from behavior information and optionally from user feedback.

The term “value attribute” refers to structured data representing a user's underlying value orientation or preference, including ethical, economic, or lifestyle-related tendencies, which is inferred from behavior information and opinion information.

The term “role information” refers to information defining a persona for a generative model, including at least one of a personality attribute, an ideology attribute, a tone attribute, and a viewpoint attribute, which influences how the model generates output.

The term “advertising target information” refers to information describing an object or subject to be promoted, including at least one of product information, service information, content information, or campaign information.

The term “style condition information” refers to information specifying constraints or preferences related to the form of generated text, including at least one of tone, length, register, level of detail, and inclusion or exclusion of particular expressions.

The term “prompt sentence” refers to one or more symbols, words, or text strings that are input to a generative model as instructions, context, or conditions for generating output data.

The term “generative AI model” refers to a parameterized computational model configured to generate data, including natural language text, based on input data such as a prompt sentence, and trained using machine learning or deep learning techniques.

The term “advertising message information” refers to information representing content of an advertisement generated by a generative model, including at least one of textual content, structured text elements, and associated metadata.

The term “user terminal” refers to an information processing device operated by a user, including at least one of a smartphone, a tablet, a personal computer, a wearable device, or any other client device capable of network communication and display.

The term “response information” refers to information indicating a user's behavioral reaction to displayed advertising message information, including at least one of impression events, click events, selection operations, navigation events, and purchase events.

The term “opinion information” refers to information explicitly expressing a user's evaluation or preference, including at least one of free-text comments, ratings, or survey responses regarding advertising message information.

The term “personality attribute” refers to information defining characteristic ways in which a generative model should express itself, including traits such as optimism, pragmatism, formality, or emotional intensity.

The term “ideology attribute” refers to information defining a conceptual or value-based stance for a generative model, including but not limited to environmental orientation, economic orientation, or social orientation.

The term “tone” refers to a qualitative characteristic of generated language, including at least one of optimistic, neutral, formal, casual, persuasive, and factual styles.

The term “viewpoint” refers to a perspective or angle from which information is expressed in generated output, including at least one of user-centric, cost-centric, environment-centric, or performance-centric perspectives.

The term “machine learning process” refers to a computational procedure in which a model is trained or executed to learn patterns from input data and to output predictions, classifications, or scores without being explicitly programmed for each case.

The term “rule-based process” refers to a computational procedure that applies predefined logical or heuristic rules to input data to derive output values, including updated attributes or decisions.

The term “predetermined condition” refers to one or more criteria specified in advance for evaluating and selecting advertising message information, including at least one of relevance thresholds, length constraints, prohibited term checks, or performance predictions.

In one embodiment, a server cooperates with one or more terminals operated by users to implement the claimed system. The server includes a processor, a main memory, a non-volatile storage device, and a network interface. The server is implemented, for example, on a general-purpose computing platform executing an operating system such as a server-class operating system, an application framework such as a web framework, a database management system such as a relational database, and a machine learning framework such as a deep learning library. The terminal is implemented, for example, as a smartphone, a tablet, or a personal computer executing a web browser or a native application.

The server stores executable program modules in the storage device. These program modules include at least: a behavior logging module, a profile inference module, a role management module, a prompt generation module, a generative AI model control module, a candidate selection module, and a feedback analysis module. The server loads these modules into the main memory and executes them by means of the processor.

The server receives behavior information from the terminal via the network interface. The terminal sends behavior information such as page view events, click events, purchase events, scrolling depth, and dwell time when the user operates the terminal. The terminal attaches a user identifier and content identifiers to such events and transmits the behavior information to the server in a structured format. The server writes the received behavior information into a behavior log stored in the storage device. In one embodiment, the behavior log is implemented as one or more tables of a relational database, each row storing fields such as user identifier, content category, event type, timestamp, and auxiliary attributes.

The server analyzes the behavior information stored in the storage device to estimate an interest attribute and a value attribute for each user. The server aggregates counts of events per content category, calculates normalized frequency vectors, and derives numerical feature vectors that represent user interaction patterns. The server applies a machine learning model, such as a feedforward neural network or a gradient-boosted decision tree, to map these feature vectors to continuous scores representing degrees of interest in topics and value orientations. For example, the server can compute an “environmental interest score,” a “cost-consciousness score,” and a “technology enthusiasm score.” The server stores the resulting interest attribute and value attribute in a user profile data structure in the storage device.

The server defines role information to control the behavior of a generative AI model. The server stores a plurality of role definitions in the storage device. Each role definition contains parameters specifying a personality attribute (for example, optimistic, pragmatic, formal), an ideology attribute (for example, environment-centered, cost-centered), a tone specification, and a viewpoint specification. The server associates each role definition with ranges of interest attributes and value attributes. For example, the server associates an “environment-centered optimistic role” with high environmental interest scores and optimistic tone preference values.

The server uses a generative AI model to generate advertising message information. In one embodiment, the generative AI model is a neural network of a transformer architecture trained on large-scale text data. The server stores parameters of the generative AI model in the storage device and loads them into the main memory. The server uses a tokenizer to convert text into token sequences and uses an inference engine to compute output token distributions layer by layer based on attention mechanisms.

The server constructs a prompt sentence and provides it to the generative AI model as input. The server retrieves the interest attribute and value attribute of a target user from the user profile, selects a role definition whose associated ranges match the user's attributes, and retrieves advertising target information for a product or service. The server then synthesizes these pieces of information into a prompt sentence according to a prescribed template. The server embeds explicit instructions about tone, viewpoint, length, and forbidden expressions.

For example, when the server determines that the user has a high environmental interest score and a preference for optimistic tone, and the advertising target is an eco-friendly reusable water bottle, the server may construct a prompt sentence such as:

System role: You are an optimistic environmentalist advisor who helps users choose sustainable products.

### User Profile

Interests: environmental protection, eco-friendly products
Values: sustainability, reducing waste
Preferred tone: optimistic and encouraging

### Task

Using the above information, write a short online advertisement (70-90 words) for a reusable water bottle made from recycled materials.

Emphasize how the product reduces single-use plastic waste and fits easily into the user's daily routine.

Use a friendly and hopeful tone.

Do not mention that you are an AI or that this text is AI-generated.

The server converts the prompt sentence into tokens and computes, using the generative AI model, probability distributions over the vocabulary for each output position conditioned on the prompt tokens. The server applies decoding algorithms such as top-p sampling with a specified temperature to select output tokens and terminates generation when a length limit or end condition is reached. The server concatenates the output tokens into text and stores the generated advertising message information in the storage device.

The server is capable of generating multiple candidate advertising messages using different role settings or different prompt sentence variations. In one embodiment, the server selects two or more role definitions that are relevant to the user's interest attribute and value attribute, and constructs corresponding prompt sentences. For example, the server may generate one prompt sentence focusing on environmental benefits and another prompt sentence focusing on cost savings:

### Version A Prompt

System role: You are an optimistic environmental advocate.

### User Profile

Interests: climate action, sustainable living
Values: reducing carbon footprint
Tone: hopeful and inspiring

### Task

Write an online advertisement (60-80 words) for an electric bicycle.

Emphasize reduced emissions and the positive environmental impact of switching from a car to an electric bicycle.

Use a future-oriented and motivational style.

Do not refer to AI or automated generation.

### Version B Prompt

System role: You are a practical advisor focused on cost-effectiveness and convenience.

### User Profile

Interests: saving money on commuting, time efficiency
Values: practicality, reliability
Tone: straightforward and informative

### Task

Write an online advertisement (60-80 words) for an electric bicycle.

Emphasize cost savings on daily commuting, reduced maintenance compared to a car, and time saved in traffic.

Use clear, factual language without emotional exaggeration.

Do not refer to AI or automated generation.

The server inputs these prompt sentences to the generative AI model sequentially or in parallel and obtains multiple pieces of advertising message information. The server then applies the candidate selection module to evaluate the candidates. The server analyzes each candidate using heuristics or another trained model that scores relevance to the user's interest attribute and value attribute, checks length constraints, and filters out prohibited words or undesirable patterns. The server selects at least one candidate that best satisfies predetermined conditions and stores an identifier of the selected candidate in the storage device.

The server transmits the selected advertising message information to the terminal via the network interface. The terminal receives the advertising message information and displays it on a graphical user interface together with product images and interactive elements such as buttons or links. The user reads the advertising message and may operate the terminal to click on the advertisement, view additional product details, add the item to a cart, or perform a purchase transaction.

The terminal sends response information and opinion information back to the server. Response information includes events such as an impression event when the advertisement is displayed, a click event, a dwell time measurement on the advertisement, and a purchase event. Opinion information includes user-entered free-text comments or ratings regarding the perceived relevance or quality of the advertisement. The server stores this information in a feedback data structure in the storage device.

The server uses the feedback analysis module to update the interest attribute and value attribute of the user. The server transforms behavior events and feedback text into numerical features; for example, the server may count positive reactions to environment-oriented ads and negative reactions to price-focused ads. The server may apply natural language processing models to detect sentiment and extract keywords from opinion information. The server then applies a machine learning process or a rule-based process to adjust the interest attribute and value attribute. For instance, the server can increase a “cost-consciousness” score when the user comments “I like eco products, but please show me the price and discounts,” and decrease an environmental score if the user repeatedly ignores environment-focused advertisements.

The server persists these updated attributes in the user profile data structure and uses them for subsequent prompt generation. As a result, future prompt sentences incorporate new constraints, such as an explicit requirement to mention price-performance balance. An updated prompt sentence may be:

System role: You are an optimistic but practical advisor who promotes eco-friendly products while respecting the user's need for affordability.

### User Profile

Interests: eco-friendly household items
Values: sustainability, cost-awareness
Tone: optimistic and practical

### Task

Generate an online advertisement (70-90 words) for a plant-based household cleaner.

Highlight both its environmental benefits and its reasonable price.

Use friendly, straightforward language and clearly mention that the product offers good value for money.

Do not refer to AI or automated generation.

By implementing the above-described data structures and algorithms, the server performs processing that goes beyond merely automating human copywriting. The server uses high-dimensional numerical feature vectors and learned mappings to manage user profiles, role selection, and prompt construction. The combination of behavior analysis, structured role management, and generative model control results in a technical improvement to computer-based content delivery systems.

The server improves processing speed and computational efficiency because the server limits generative AI inference to a small, carefully selected set of role configurations and prompt patterns that are determined based on precomputed user attributes. Instead of exhaustively generating and testing many arbitrary messages, the server uses learned mappings from behavior information to role information and style constraints, thereby reducing the number of model invocations necessary to reach a high-quality advertisement. The server also improves accuracy by aligning internal model conditions with empirically observed user responses; over time, the feedback analysis module tunes the user profile attributes to better predict which role and tone will yield desired reactions.

The server improves data management because the server maintains a consistent, structured representation of user interests and values across multiple sessions and devices. The user profile data structure, stored in the storage device and updated by feedback analysis, serves as a centralized technical resource that organizes noisy, raw logs and free-text feedback into machine-usable numerical attributes. This reduces redundant computations and communication overhead, as the server does not need to repeatedly analyze all raw logs for each request; instead, the server reuses the summarized attributes to construct prompt sentences.

The server further improves technical operation of the generative AI model by enforcing non-conventional control rules at inference time. Conventional usage of generative models often relies on generic prompts without dynamic persona control. In contrast, the server embeds explicit persona and ideology parameters in the prompt sentence, determined from structured role definitions that are themselves derived from learned correlations between user features and content performance. This non-standard, role-conditioned inference procedure yields more stable and predictable model behavior, reducing variance in generated content and lowering the need for downstream filtering.

In another embodiment, the server uses alternative generative model architectures, such as encoder-decoder transformers or recurrent neural networks with attention, while maintaining the same control logic via prompt sentences or equivalent conditioning mechanisms. The server may also replace or augment the neural network component with a rule-based generation engine for specific domains while still using the same user profile and role information.

In another embodiment, the server executes the behavior analysis and feedback analysis modules on specialized hardware accelerators, such as graphics processing units or tensor processing units, to further reduce latency. The server may also distribute profile computation across multiple machines and maintain a cache of frequently accessed user profiles to reduce database query loads. These variations maintain the same functional relationships between behavior information, role information, prompt generation, generative AI inference, candidate selection, and feedback-driven updates.

The terminal, in all embodiments, operates as an input/output device that provides user interaction data to the server and displays the personalized advertising message information generated by the server. The user, by interacting with the terminal, supplies behavior information and opinion information that drive the adaptive learning loop. Through this cooperation, the system as a whole achieves technical effects such as improved personalization precision, reduced computation and communication overhead, and increased stability and controllability of generative AI outputs within a computer-implemented advertising platform.

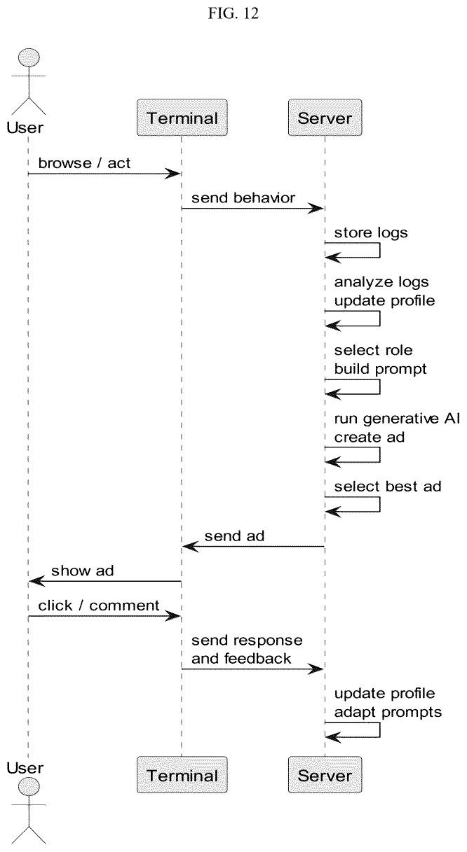

The following describes the processing flow using FIG. 12.

### Step 1

The terminal monitors user operations and generates behavior information. The terminal receives, as input, low-level interaction events such as page loads, link clicks, button presses, scrolling movements, and purchase confirmations. The terminal processes these raw events by attaching a user identifier, a content identifier, a category label, a timestamp, and a device identifier to each event, and the terminal aggregates the events into structured behavior records. The terminal outputs behavior information in the form of structured records ready to be transmitted to the server.

### Step 2

The terminal transmits the behavior information to the server. The terminal receives, as input, the structured behavior records generated in Step 1, and the terminal serializes these records into a request payload. The terminal then sends the payload to the server over a network using a communication protocol. As a result, the terminal outputs network messages that carry user behavior information to the server.

### Step 3

The server stores the received behavior information in a storage device. The server receives, as input, the behavior records contained in the network messages from the terminal, and the server parses and validates the records. The server then performs data processing that includes checking required fields, normalizing timestamps, and mapping content identifiers to content categories. Based on these operations, the server writes each validated record into one or more tables or collections in the storage device. The server outputs persistent behavior log entries that can be queried and analyzed later.

### Step 4

The server aggregates behavior information to compute intermediate statistics. The server receives, as input, the persistent behavior log entries for a given user obtained from the storage device. The server groups the entries by content category and event type, counts occurrences, and computes normalized frequencies and recency-weighted scores. The server may also compute temporal features such as average session duration or typical access times. The server outputs an intermediate feature vector that numerically summarizes the user's interaction pattern.

### Step 5

The server infers an interest attribute and a value attribute from the intermediate feature vector. The server receives, as input, the feature vector computed in Step 4. The server applies one or more inference methods, which may include a trained neural network, a linear model, or a rule set, to map elements of the feature vector to continuous scores or categorical labels that represent topical interests and value orientations. For example, the server may compute an environmental interest score, a cost-consciousness score, and a technology enthusiasm score. The server then organizes these scores into a structured profile object. The server outputs an updated user profile containing the inferred interest attribute and value attribute.

### Step 6

The server stores and maintains the user profile in a profile repository. The server receives, as input, the profile object generated in Step 5. The server compares the new attributes with previously stored values for the same user, applies update rules or smoothing (for example, weighted averaging between old and new scores), and resolves conflicts. The server then writes the merged profile back into a dedicated profile data structure in the storage device. The server outputs a persistent, up-to-date user profile that can be retrieved for subsequent processing.

### Step 7

The server selects role information based on the user profile. The server receives, as input, the current user profile and a set of pre-defined role definitions stored in the storage device. The server compares the interest attribute and value attribute of the user with threshold conditions or mapping rules associated with each role definition. Based on this comparison, the server determines at least one suitable role whose personality attribute, ideology attribute, tone, and viewpoint match the user's inferred characteristics. The server outputs selected role information that specifies how the generative AI model should behave for this user.

### Step 8

The server composes a prompt sentence using the role information, the user profile, and advertising target information. The server receives, as input, the selected role information from Step 7, the user profile from Step 6, and advertising target information such as product name, product features, and campaign constraints. The server merges these inputs into a structured template and performs string operations to construct natural language instructions that define system role, user characteristics, required tone, length, and content focus. The server explicitly inserts constraints such as “do not refer to AI” or “mention price-performance balance.” The server outputs a complete prompt sentence that conditions the behavior of the generative AI model.

### Step 9

The server generates advertising message information by using a generative AI model controlled by the prompt sentence. The server receives, as input, the prompt sentence created in Step 8. The server converts the prompt sentence into a sequence of tokens according to the vocabulary of the generative AI model and then forwards the token sequence to the model's inference engine. The generative AI model processes the token sequence through its layers to compute probability distributions over output tokens. The server applies a decoding strategy, such as sampling or constrained selection, to choose output tokens step by step, and concatenates the chosen tokens into a text string. The server outputs advertising message information in the form of a complete advertisement text generated under the control of the prompt sentence.

### Step 10

The server optionally generates multiple advertising message candidates by varying role information or prompt content. The server receives, as input, a set of candidate role definitions and variations of advertising constraints, along with the user profile. The server repeats Steps 8 and 9 for each role or variation, thereby constructing multiple prompt sentences and invoking the generative AI model for each prompt. The server gathers all generated texts and associates each text with the corresponding role and parameters used during generation. The server outputs a set of candidate advertising message information items for the same user and advertising target.

### Step 11

The server evaluates and selects one or more advertising message candidates based on predetermined conditions. The server receives, as input, the set of candidate advertising message information items from Step 10 and relevance criteria, length limits, and safety or content rules stored in the storage device. The server parses each candidate, measures characteristics such as word count, presence of required keywords, and absence of prohibited terms, and optionally computes a relevance score using a scoring model or rule-based logic. Based on these computations, the server ranks the candidates and selects at least one candidate that satisfies the predetermined conditions. The server outputs a selected advertising message and associated metadata such as a candidate identifier and role identifier.

### Step 12

The server transmits the selected advertising message information to the terminal for display. The server receives, as input, the selected advertising message and metadata from Step 11. The server formats the advertisement text and metadata into a response structure and sends this response to the terminal via the network interface. The server then records a delivery event in the storage device, associating the user, the advertisement, and the time of transmission. The server outputs a network response that delivers the advertising message to the terminal.

### Step 13

The terminal receives and displays the advertising message information to the user. The terminal receives, as input, the response from the server containing the advertisement text and metadata. The terminal parses the response and integrates the advertising text into a graphical user interface element such as a banner area or recommendation panel. The terminal may apply layout rules, fonts, and colors defined by a local configuration. The terminal outputs a rendered advertisement on the display, making the advertising message available for viewing by the user.

### Step 14

The user reads and reacts to the displayed advertisement. The user receives, as input, the advertising message rendered on the terminal display. The user may perform operations such as tapping a link to view details, scrolling past the advertisement without interaction, adding a product to a cart, or entering a free-text comment about the advertisement. The user's actions produce observable events that the terminal can capture as new behavior or opinion information. The user outputs implicit responses (through interaction patterns) and explicit opinions (through typed comments or selections).

### Step 15

The terminal records and transmits response information and opinion information to the server. The terminal receives, as input, the user's interactions and any entered comments regarding the advertisement displayed in Step 13. The terminal converts these interactions into structured response information, such as impression events, click events, and purchase events, and converts comments or ratings into structured opinion information linking them to the advertisement identifier. The terminal aggregates these records and transmits them to the server via the network interface. The terminal outputs updated response and opinion information that will be used for further analysis.

### Step 16

The server analyzes response information and opinion information to update the user profile. The server receives, as input, the response and opinion information sent by the terminal in Step 15, along with the existing user profile from the storage device. The server calculates statistics such as click-through rates for certain role types, dwell time on ads of different tones, and frequencies of particular feedback phrases. The server may apply a machine learning model or rule set that maps these features to adjustments in the user's interest attribute and value attribute. For example, the server may increase a cost-consciousness score when the user frequently responds positively to price-focused messages, or add a new tag indicating environmental fatigue when the user consistently ignores environment-centric ads. The server writes the updated attributes back into the profile repository. The server outputs a refined user profile that more accurately reflects the user's current preferences and values.

### Step 17

The server adapts future prompt sentences and role selections based on the updated user profile. The server receives, as input, the refined user profile from Step 16 and the set of role definitions and advertising campaign parameters. The server re-evaluates which roles are appropriate given the new attribute values and updates mapping thresholds or priority orders among roles. When a new advertising request is processed, the server uses the refined profile to construct a prompt sentence that may include new constraints, such as a stronger emphasis on affordability or a reduced emphasis on a previously dominant topic. The server thereby transforms the updated profile into modified role selections and modified prompt sentence content. The server outputs adapted role information and prompt sentence templates that will be used as inputs for subsequent executions of Steps 8 and 9.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems using a generative AI model generally accept a single prompt sentence from a user and directly return a single generated response. In such systems, the model's internal biases and latent tendencies are reflected in the response in an opaque manner. As a result, the user may receive information that is implicitly skewed toward a particular positive, negative, or neutral stance without clear separation of viewpoints. Furthermore, conventional systems typically treat the prompt sentence as a monolithic input and do not systematically decompose it into multiple internal prompt sentences designed to elicit a plurality of viewpoints. This limits the system's ability to provide multi-perspective information and makes it difficult for the user to understand the distribution and direction of the model's outputs.

In addition, in many existing implementations, processing pipelines do not explicitly remove or reduce feature quantities that are dependent on speaker attributes, wording impressions, or other non-substantive cues. As a result, generated information may still inherit or amplify biases that resemble human communication biases (such as those based on the apparent authority or style of an imagined speaker), even though the generative AI model itself is not an actual person. This prevents the system from fully exploiting the potential advantage of a non-human information source that could otherwise attenuate such biases.

Moreover, conventional servers that interface with a generative AI model often lack an integrated mechanism for logging prompt sentences and corresponding generated information as structured analysis data that can be reused for controlling or tuning the generative AI model. Without such systematic accumulation and analysis, it is difficult to monitor output tendencies, to visualize them to the user, or to improve the computational behavior of the system over time. Consequently, there is a need for a computer-implemented technique that improves the way prompt sentences are processed, how multi-viewpoint responses are generated and structured, and how bias is reduced and made visible, thereby improving the overall operation of the generative AI model and the server that controls it.

Accordingly, there is a demand for an improved server-side architecture and processing method that: (i) converts a single user prompt sentence into multiple internal prompt sentences associated with explicitly different viewpoints; (ii) acquires multiple generated pieces of information from a generative AI model and integrates them into structured, multi-perspective, low-bias information; (iii) performs explicit information processing to remove or reduce bias-inducing feature quantities tied to speaker attributes or wording impressions; and (iv) accumulates prompt-and-response pairs as analysis data that can be used to visualize and control the output tendencies of the generative AI model. Such improvements should be realized as a concrete enhancement of computer technology, namely as improved server-side information processing that changes how data is structured, processed, stored, and presented in connection with a generative AI model.

The specific processing by the specific processing unit 290 of the data processing device 12 in Example 2 is realized by the following means.

The present invention provides a server comprising a processor configured to receive, from a user terminal, a prompt sentence as an instruction for causing a generative AI model to generate information, to convert the received prompt sentence into a plurality of internal prompt sentences that respectively correspond to different viewpoints including at least a positive viewpoint, a negative viewpoint, and a neutral viewpoint, to input the plurality of internal prompt sentences to the generative AI model and acquire a plurality of generated pieces of information corresponding respectively to the plurality of internal prompt sentences, to integrate the acquired plurality of generated pieces of information into integrated generated information that is structured in a manner distinguishable by viewpoint and reduced in bias, to perform information processing on the prompt sentence and the plurality of generated pieces of information to remove or reduce feature quantities dependent on speaker attributes or impressions of wording, to store information relating to the prompt sentence and the integrated generated information in association with identification information as analysis data in a storage device, and to transmit the integrated generated information to the user terminal via a communication network for presentation as a multi-viewpoint response. This enables a computer-implemented improvement in server-side processing for generative AI, including systematic multi-viewpoint generation from a single prompt sentence, structured integration of generated information with reduced bias, explicit suppression of speaker-related bias features, and accumulation and utilization of analysis data to control and make visible the output tendencies of the generative AI model, thereby improving the technical performance and reliability of information generation in the system.

The term “processor” refers to a hardware processing unit or a combination of hardware processing units, such as a central processing unit, a graphics processing unit, or another arithmetic logic unit, that executes instructions to perform information processing operations described in the present specification.

The term “user terminal” refers to an electronic device operated by a user, such as a personal computer, a mobile communication device, or another client device, that is configured to transmit a prompt sentence to a server and to present information received from the server.

The term “prompt sentence” refers to text data input by a user or generated by a system, which functions as an instruction for causing a generative AI model to generate information in response to the content of the text.

The term “internal prompt sentence” refers to text data that is derived by the processor from a prompt sentence and that is configured for input to a generative AI model, the internal prompt sentence being associated with a particular viewpoint or aspect for which information is to be generated.

The term “generative AI model” refers to a software-implemented artificial intelligence model, typically based on machine learning or deep learning, that receives a prompt sentence as input and outputs generated information such as text or other data based on learned parameters.

The term “viewpoint” refers to a perspective or stance, such as a positive perspective, a negative perspective, or a neutral perspective, from which a generative AI model is requested to generate information regarding a subject.

The term “positive viewpoint” refers to a viewpoint that emphasizes advantageous, beneficial, or favorable aspects of a subject when information is generated by a generative AI model.

The term “negative viewpoint” refers to a viewpoint that emphasizes disadvantageous, harmful, or unfavorable aspects of a subject when information is generated by a generative AI model.

The term “neutral viewpoint” refers to a viewpoint that emphasizes factual, balanced, or non-judgmental aspects of a subject without prioritizing positive or negative evaluations when information is generated by a generative AI model.

The term “generated piece of information” refers to an output generated by a generative AI model in response to an input prompt sentence, the output including text or other data that expresses information corresponding to the content of the input.

The term “integrated generated information” refers to information obtained by combining a plurality of generated pieces of information, the information being structured so that differences in viewpoint or aspect among the generated pieces of information are distinguishable.

The term “structured data” refers to data that is arranged in a predetermined format, such as records, fields, tags, or sections, so that individual elements of information, including viewpoints and contents, can be identified, processed, and presented in a systematic manner.

The term “bias” refers to a tendency of generated information to be systematically inclined toward a particular evaluation, perspective, or attribute, including tendencies caused by training data, model parameters, or features related to speaker attributes or wording impressions.

The term “feature quantity” refers to a numerical or symbolic representation of a characteristic extracted from a prompt sentence or generated piece of information, such as a feature associated with a speaker attribute, a wording style, or an evaluative tone, which may influence the behavior of a generative AI model.

The term “speaker attribute” refers to information or characteristics associated with a hypothetical or actual speaker, such as social status, prominence, demographic attribute, or role, which may implicitly or explicitly affect how information is interpreted or generated.

The term “impression of wording” refers to an evaluative or stylistic characteristic of phrasing, such as politeness, assertiveness, emotional strength, or rhetorical style, which can influence perceived meaning or bias in a text.

The term “recording medium” refers to any tangible or non-transitory storage medium capable of storing data, such as a semiconductor memory, a magnetic storage device, an optical storage device, or another storage apparatus accessible by the processor.

The term “identification information” refers to data that associates a prompt sentence and integrated generated information with a particular context, such as a session identifier, a transaction identifier, or another identifier, without necessarily including personally identifiable information.

The term “analysis data” refers to data accumulated from prompt sentences, generated pieces of information, and integrated generated information, which is used by a system to analyze, control, or improve the behavior or output tendencies of a generative AI model.

The term “communication network” refers to a wired or wireless data transfer infrastructure, such as the Internet, a local area network, or a mobile communication network, that enables transmission and reception of data between a server and a user terminal.

The term “multi-viewpoint response” refers to a response that presents information generated from a plurality of viewpoints, such as positive, negative, and neutral viewpoints, in a manner that allows a user to distinguish and compare the different viewpoints.

In one embodiment, a server cooperates with a terminal and a user to implement a system that provides multi-perspective, low-bias information generated by a generative AI model in response to a prompt sentence. The server includes at least one processor, a main memory, a non-transitory storage device, and a network interface. The terminal includes at least one processor, a display, an input interface, a memory, and a communication interface. The user operates the terminal to input the prompt sentence and to view information returned from the server.

The server executes an application program stored in the storage device and loaded into the main memory. The server may use an operating system such as a general-purpose server operating system, and a web server framework such as a generic HTTP server coupled with an application framework that processes API requests. The application program is implemented, for example, using a general-purpose programming language and a web framework that parses HTTP requests, manages sessions, and performs JSON serialization and deserialization. The server further includes a model interface module that communicates with the generative AI model and a data management module that stores prompt sentences and generated information as analysis data.

The terminal executes a client application, which may be a web browser or a dedicated application. The terminal displays an input area for a prompt sentence and a display area for generated information. The terminal uses a communication protocol such as HTTPS over TCP/IP to send the prompt sentence to the server and to receive the generated information. The terminal may store a history of prompt sentences and responses in a local storage area to allow the user to review past interactions.

The user operates the terminal to input a prompt sentence in natural language. For example, the user may input a prompt sentence such as “Please tell me about the future of AI technology, including possible social impacts, economic benefits, and ethical challenges.” In another example, the user may input “Using multiple perspectives, explain the advantages and disadvantages of adopting a new financial technology in developing countries.” In a further example, the user may input “Provide a balanced explanation of nuclear energy, covering both its potential benefits for clean energy and its safety and waste management concerns.” The terminal displays a text input field, receives the user's keystrokes, and forms the prompt sentence as character data encoded in a standard character set.

The server receives the prompt sentence from the terminal through the network interface. The server validates the prompt sentence by checking that its length is within predetermined bounds, that the character encoding is valid, and that control characters are removed. The server may also perform preliminary filtering, such as removing or masking prohibited words according to a stored list. The server then normalizes the prompt sentence, for example, by converting full-width characters to half-width characters in certain languages, standardizing punctuation, and performing Unicode normalization. These operations are performed by the processor using string processing routines stored in the application program.

The server constructs a plurality of internal prompt sentences based on the received prompt sentence. The server uses a rule-based transformation module that applies predefined templates to the prompt sentence to generate multiple internal prompt sentences corresponding to different viewpoints. For example, the server generates a first internal prompt sentence by concatenating a phrase indicating a positive viewpoint with the original prompt sentence, such as “From a positive viewpoint, explain: ” followed by the original prompt sentence. The server generates a second internal prompt sentence by concatenating a phrase indicating a negative viewpoint with the original prompt sentence, such as “From a negative viewpoint, explain: ” followed by the original prompt sentence. The server generates a third internal prompt sentence by concatenating a phrase indicating a neutral viewpoint with the original prompt sentence, such as “From a neutral and fact-based viewpoint, explain:” followed by the original prompt sentence.

The server uses data structures in memory to store the internal prompt sentences. For example, the server stores the internal prompt sentences in a list or an array, and associates each element with a viewpoint label such as “positive,” “negative,” or “neutral.” The server may also include additional viewpoints, such as “long-term impact,” “short-term risk,” or “regulatory perspective,” by applying further templates. By structuring the data in this way, the server controls the behavior of the generative AI model so that the model produces outputs that are explicitly separated by viewpoint.

The server interfaces with the generative AI model using a model interface module. In one embodiment, the generative AI model is deployed on a separate computing apparatus, such as a dedicated inference server equipped with one or more GPUs. The server sends the internal prompt sentences as input data to the generative AI model through an API. The API may use a request-response protocol where the internal prompt sentences and model parameters are encoded in a structured format and transmitted via HTTPS. In another embodiment, the generative AI model is executed locally on the same server hardware, and the server invokes the model through a software library providing an inference function.

The generative AI model is implemented as a neural network, for example a Transformer-based language model. The generative AI model includes an embedding layer, a plurality of self-attention layers, feedforward layers, and an output layer. The embedding layer converts tokens into vector representations. The self-attention layers compute attention weights between tokens and perform matrix multiplications and nonlinear activations. The output layer generates probability distributions over vocabulary tokens. The model parameters, including weight matrices and bias vectors, are stored in a non-transitory storage medium and loaded into memory when the model is used for inference.

The server uses the model interface module to specify generation parameters for the generative AI model, such as maximum output length, temperature, top-k sampling, and top-p sampling. The server adjusts these parameters to balance diversity and consistency of the generated information. The server transmits each internal prompt sentence and associated parameters to the generative AI model and receives a generated piece of information for each internal prompt sentence. The generated piece of information is returned as a sequence of tokens, which the model interface module decodes into a text string.

The server post-processes each generated piece of information. The server removes undesirable characters, normalizes whitespace, and may apply further filtering to remove or mask prohibited content. The server stores the generated pieces of information in memory together with their viewpoint labels. The server then integrates the generated pieces of information into integrated generated information. In one implementation, the server constructs a structured data object that includes fields for each viewpoint and the corresponding generated text. The server may also generate headings, such as “Positive Viewpoint,” “Negative Viewpoint,” and “Neutral Viewpoint,” and interleave them with the corresponding generated text. This structured integration allows the terminal to display the information in a way that clearly distinguishes the viewpoints.

The server performs explicit processing to remove or reduce feature quantities that are dependent on speaker attributes or impressions of wording. The server uses a feature analysis module that applies natural language processing techniques to detect features such as first-person references, references to authority, or stylistic signals of strong emotion. The feature analysis module may use a separate classification model or rule-based patterns to assign scores to sentences for features such as “authoritative tone,” “emotional intensity,” or “personal attribution.” The server modifies the generated text by transforming or removing phrases that exceed predefined thresholds for such features. For example, the server may replace phrases like “experts agree that” with more neutral phrases like “it is often considered that,” or remove explicit references to a hypothetical speaker's social status. By performing these modifications at the text level, the server reduces bias related to perceived speaker attributes and wording impressions.

The server stores the prompt sentence, the internal prompt sentences, the associated viewpoint labels, and the integrated generated information as analysis data in a storage device. The analysis data may be stored as records in a relational database or as documents in a document-oriented database. Each record includes identification information, such as a session identifier or a transaction identifier, which allows the system to group related requests and responses. The server may also store metadata such as timestamps, model version identifiers, and generation parameters. By accumulating this analysis data, the server can later perform statistical analysis of output tendencies, such as the distribution of positive versus negative content, and can adjust templates, parameters, or model selection accordingly.

The server transmits the integrated generated information to the terminal via the communication network. The integrated generated information is encoded as structured data and sent as a response message. The terminal receives the response, parses the structured data, and displays the integrated generated information on the display. The terminal may present each viewpoint in a separate section, using headings and distinct visual formatting. The user can scroll through the sections and compare the content across viewpoints. The terminal may allow the user to collapse or expand each viewpoint section to manage screen space.

The server uses this architecture to improve computer technology in several ways. First, the server changes the data structure of the prompt handling process from a single-string input to a structured set of internal prompt sentences with explicit viewpoint labels. This structured decomposition is not a mere automation of human reading, but a specific computational reorganization that enables the generative AI model to be driven in a controlled, multi-viewpoint mode. The server thus improves the efficiency and predictability of the generative AI model's outputs by reducing the need for repetitive user interaction to obtain multiple perspectives.

Second, the server introduces non-conventional server-side processing that applies rule-based viewpoint expansion, neural network inference, and bias-reducing text transformations in a pipeline that is optimized for execution on computing hardware. The use of internal prompt sentences and viewpoint labels allows the server to parallelize calls to the generative AI model when multiple processing units are available. Parallelization reduces overall response latency and improves throughput, thereby improving processing speed compared to sequential, manual querying for different viewpoints.

Third, the server improves data management by storing prompt sentences, internal prompt sentences, viewpoint labels, generation parameters, and generated outputs as structured analysis data. This structured storage enables efficient indexing and retrieval of past interactions. The server can quickly identify patterns of bias or output degradation and adjust processing rules or model parameters. This capability constitutes an improvement in computer-based data management because it defines specific data schemas tailored to generative AI interactions and enables targeted analysis and control.

Fourth, the server reduces network load and computation redundancy by generating multiple viewpoint outputs from a single original prompt sentence. Instead of requiring the user to send multiple separate prompt sentences for each viewpoint, the server internally generates and manages the internal prompt sentences. This reduces the number of network round trips between the terminal and the server and decreases redundant processing in the generative AI model. The result is a reduction in communication overhead and an improvement in overall system efficiency.

Fifth, the server explicitly controls feature quantities related to speaker attributes and wording impressions, which are not typically manipulated by human users in real time. The server uses algorithmic detection and transformation of such features based on predetermined rules and learned models. This algorithmic processing follows a set of rules that differ from human cognitive strategies and operates at scale on text streams. As a result, the system reduces a class of biases that are difficult for humans to manage manually and improves the technical quality of the generated outputs, such as by reducing error rates related to misinterpretation of authority or emotional tone.

In another embodiment, the server configures the generative AI model and its training. The server prepares training data that includes pairs of prompt sentences and multi-viewpoint responses. The server uses an offline training pipeline executed on a training apparatus that includes GPUs or other accelerators. The training apparatus loads a large corpus of text, tokenizes the text, and constructs input-output pairs. The server defines a loss function, such as a cross-entropy loss over token predictions, and performs gradient-based optimization such as stochastic gradient descent or an adaptive optimizer. The training process adjusts weight parameters of the Transformer network so that the model better responds to internal prompt sentences that specify viewpoints. The server may augment the data by generating synthetic internal prompt sentences with explicit viewpoint tags and corresponding target outputs. This data augmentation improves the model's ability to respond in a structured, multi-viewpoint manner.

In a further embodiment, the server deploys multiple generative AI models with different sizes or architectures. The server selects a model based on criteria such as prompt length, required response latency, or system load. For shorter prompt sentences or where quick responses are required, the server may select a smaller model with fewer layers and parameters. For more complex prompt sentences, the server may select a larger model with more layers and a larger context window. The server maintains a model selection module that uses heuristics or a learned classifier to choose the model. This dynamic model selection improves computational efficiency and resource utilization in the computing environment.

In yet another embodiment, the server provides visualization data to the terminal that indicates output tendencies of the generative AI model. The server analyzes accumulated analysis data to compute statistics such as the ratio of positive to negative content, the distribution of sentiment scores, or the frequency of certain types of bias-inducing features. The server sends these statistics to the terminal together with integrated generated information. The terminal displays charts or indicators that help the user understand the tendency of the model's outputs over time. This visualization is based on concrete numerical data derived from machine processing and supports technical control of the model rather than mere business reporting.

The user can apply the system in various applications, such as risk evaluation of new technologies, balanced information provision in educational settings, or multi-perspective assessment of policy proposals. In each application, the system operates through the described hardware and software components, with the server performing structured prompt transformation, neural-network-based generation, bias-reducing post-processing, structured storage, and analysis. The system thereby provides an implementation that can be realized using conventional server and terminal hardware, but with a specific architecture and processing sequence that improve the functioning of the computer system itself in handling generative AI interactions and multi-viewpoint information generation.

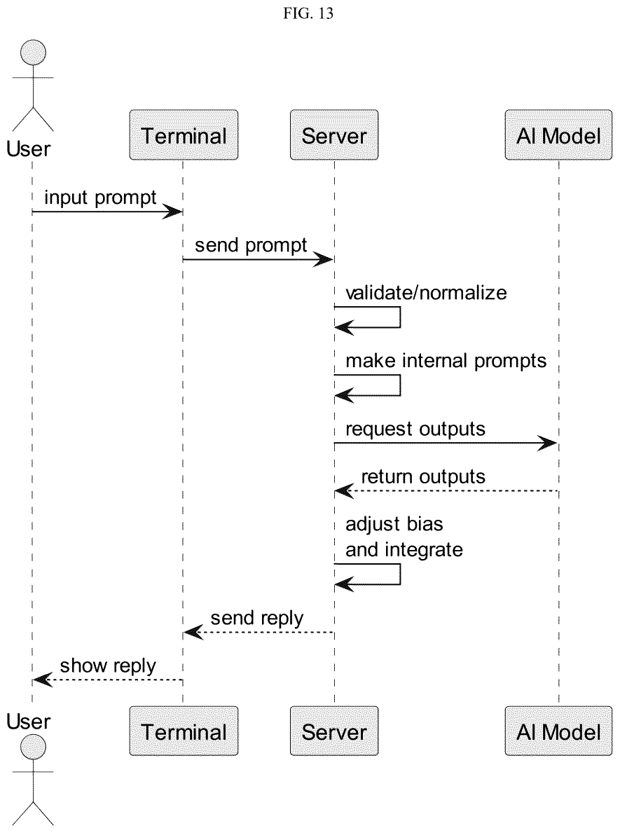

The following describes the processing flow using FIG. 13.

### Step 1

The user operates the terminal to input a prompt sentence.

The terminal receives, as input, raw key events and touch events from the user, converts these events into a text string according to the terminal's keyboard layout and character encoding, and displays the resulting prompt sentence in an on-screen text field. The terminal outputs the finalized prompt sentence as character data (for example, a UTF-8 string) when the user activates a send or submit control.

### Step 2

The terminal validates and normalizes the prompt sentence.

The terminal receives, as input, the prompt sentence string produced in Step 1, and performs data processing including trimming leading and trailing whitespace, checking that the character count is within a configured range, and verifying that the characters conform to a supported encoding. The terminal also replaces control characters with safe placeholders or removes them. The terminal outputs a sanitized prompt sentence string suitable for network transmission.

### Step 3

The terminal transmits the prompt sentence to the server.

The terminal receives, as input, the sanitized prompt sentence string from Step 2 and constructs a request message, including the prompt sentence and session-related metadata, according to a communication protocol such as HTTPS. The terminal performs data processing to encapsulate the prompt sentence into a request body, sets necessary headers, and passes the message to the communication interface. The terminal outputs a network packet sequence that is delivered to the server over a communication network.

### Step 4

The server receives and parses the prompt sentence.

The server receives, as input, the network packet sequence from Step 3 via its network interface and reconstructs the request message. The server performs data decoding to retrieve the request body, parses the body using a request-handling framework, and extracts the prompt sentence string along with any session identifiers. The server outputs the extracted prompt sentence as an internal variable stored in main memory and an associated context object containing metadata.

### Step 5

The server validates and normalizes the prompt sentence.

The server receives, as input, the prompt sentence and context object from Step 4. The server performs data checks, including length verification, character set validation, and detection of disallowed patterns based on a stored rule set. The server also applies normalization operations such as Unicode normalization, standardization of punctuation, and conversion of specific script variants. The server outputs a validated and normalized prompt sentence string and an updated context object indicating that validation has succeeded.

### Step 6

The server generates multiple internal prompt sentences with viewpoint labels.

The server receives, as input, the normalized prompt sentence from Step 5. The server performs rule-based text processing to construct multiple internal prompt sentences by concatenating predefined viewpoint prefixes or templates with the normalized prompt sentence. For example, the server creates:
a first internal prompt sentence for a positive viewpoint by adding a positive-viewpoint instruction phrase,
a second internal prompt sentence for a negative viewpoint by adding a negative-viewpoint instruction phrase, and
a third internal prompt sentence for a neutral viewpoint by adding a neutral and fact-based instruction phrase.

The server stores each internal prompt sentence together with an explicit viewpoint label in a data structure such as a list of records. The server outputs this collection of viewpoint-labeled internal prompt sentences as structured data.

### Step 7

The server prepares model input data for the generative AI model.

The server receives, as input, the structured data containing internal prompt sentences and viewpoint labels from Step 6. The server performs data assembly to create model input objects that include, for each internal prompt sentence, generation parameters such as maximum token length, temperature, sampling configuration, and any control tokens or tags required by the generative AI model. The server encodes the internal prompt sentences into the input format expected by the model interface (for example, by converting them to token sequences or constructing a request payload). The server outputs a set of model input data items, each corresponding to one internal prompt sentence.

### Step 8

The server sends the model input data to the generative AI model and requests generation.

The server receives, as input, the set of model input data items from Step 7. The server invokes a model interface module to transmit each model input to the generative AI model. When the generative AI model is remote, the server serializes the inputs into request messages and sends them via a network protocol; when the model is local, the server calls inference functions and passes the tokenized inputs and generation parameters. The server outputs invocation commands and associated data to the generative AI model, thereby initiating deep learning computations.

### Step 9

The server obtains generated pieces of information from the generative AI model.

The server receives, as input, model outputs returned by the generative AI model in response to the invocations from Step 8. Each model output includes a sequence of tokens or a text string representing generated information corresponding to one internal prompt sentence. The server decodes token sequences into text, if necessary, and associates each generated text with the corresponding viewpoint label by referencing the mapping created in Step 6. The server outputs a set of generated pieces of information, each paired with its viewpoint label.

### Step 10

The server performs bias-related feature analysis and adjustment on generated pieces of information.

The server receives, as input, the viewpoint-labeled generated pieces of information from Step 9. The server applies a feature analysis module that uses rule-based patterns or auxiliary models to detect features indicative of speaker attributes or wording impressions, such as authority references, high emotional intensity, or strong personal attribution. The server computes feature values for segments of text and compares those values to preset thresholds. For segments exceeding the thresholds, the server performs text transformations, including replacing authority phrases with neutral phrasing, moderating extreme emotional wording, or removing explicit speaker-role statements. The server outputs adjusted generated pieces of information that have reduced dependence on speaker-related and stylistic bias features, together with their viewpoint labels.

### Step 11

The server integrates the generated pieces of information into structured integrated generated information.

The server receives, as input, the adjusted viewpoint-labeled generated pieces of information from Step 10. The server constructs a structured data object, such as a record or document, with fields for each viewpoint and corresponding text content. The server optionally adds labels or headings (for example, “Positive Viewpoint,” “Negative Viewpoint,” “Neutral Viewpoint”) and orders the sections in a predetermined sequence. The server performs string concatenation, field assignment, and formatting operations to combine the individual texts into a single integrated representation while preserving viewpoint distinctions. The server outputs integrated generated information as structured data that can be directly rendered by the terminal.

### Step 12

The server logs analysis data for control and monitoring of the generative AI model.

The server receives, as input, the normalized prompt sentence from Step 5, the internal prompt sentences and viewpoint labels from Step 6, the generation parameters from Step 7, and the integrated generated information from Step 11. The server creates an analysis record containing these elements along with identification information such as a session identifier and a timestamp. The server performs data insertion into a storage system, for example by writing the record to a database or log storage. The server outputs a stored entry that can later be retrieved for analysis of model output tendencies, bias monitoring, and system tuning.

### Step 13

The server transmits the integrated generated information to the terminal.

The server receives, as input, the integrated generated information from Step 11 and any additional display metadata. The server serializes the structured integrated information into a response message formatted according to an application protocol, sets appropriate headers, and sends the message through the network interface to the terminal over the communication network. The server outputs a sequence of response packets containing the integrated generated information.

### Step 14

The terminal receives and decodes the integrated generated information.

The terminal receives, as input, the response packets from Step 13 via its communication interface. The terminal reconstructs the response message, parses the message body to extract the structured integrated generated information, and converts it into in-memory data structures suitable for rendering. The terminal outputs the integrated generated information and associated structure (for example, viewpoint sections and headings) as display-ready data.

### Step 15

The terminal renders the multi-viewpoint response for the user.

The terminal receives, as input, the display-ready integrated generated information from Step 14. The terminal performs user interface processing to map each viewpoint section to a visual component on the display, applies formatting such as headings, indentation, or color coding, and updates the screen content. The terminal outputs a rendered display in which the user can visually distinguish and compare the positive, negative, and neutral viewpoints as generated by the generative AI model under the control of the server.

### Step 16

The user reviews the multi-viewpoint response and optionally inputs a follow-up prompt sentence.

The user receives, as input, the visual information presented on the terminal display in Step 15 and interprets the comparative viewpoints. Based on this information, the user may decide to refine the query, for example by entering a follow-up prompt sentence focusing on a particular aspect such as regulatory issues or long-term risks. The user's new input becomes a new prompt sentence that, when confirmed, is output by the terminal as new character data and re-enters the processing flow starting from Step 1.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional natural language generation systems that employ generative AI models typically treat the model as a single, static component that returns text in response to user input. Such systems suffer from several technical limitations at the computing-system level.

First, the generative AI model is generally invoked with simple, fixed prompt text that does not adequately encode dynamic context, such as audiovisual content being viewed, distribution-platform metadata, or a user's current emotional state. As a result, server resources are consumed to generate responses that are poorly adapted to the actual context, which increases unnecessary model invocations, network traffic, and postprocessing, and degrades overall system efficiency.

Second, conventional architectures generally handle only a single “viewpoint” or “persona” per request. The server therefore performs repeated, independent calls to the same model to simulate multiple viewpoints, without any structured orchestration. This leads to redundant computation on the server, increased latency for end users, and difficulty in aggregating multi-perspective outputs into a coherent representation that a client device can efficiently render and compare.

Third, many existing systems lack a mechanism at the processor level to systematically integrate emotion analysis with prompt construction and response selection. Emotion-analysis components, where present, are often loosely coupled and do not directly influence which prompts are generated, which model attributes are applied, or which responses are prioritized. This results in additional processing cycles on both the server and the network for generating and filtering responses that are not aligned with the user's emotional state, thereby reducing computational efficiency and user experience.

Fourth, the postprocessing of generated responses is typically ad hoc, relying on simple length limits or keyword filtering applied at the application layer. There is no unified control loop in which the processor uses distribution-platform metadata, persona configuration, and emotion information to coordinate preprocessing of training data, construction of context-rich prompt sentences, generation of multiple responses, and structured postprocessing under explicit constraints to reduce bias and enforce safe, neutral presentation conditions. This fragmented processing pipeline complicates implementation, increases memory and CPU load, and makes it difficult to guarantee consistent, bias-reduced behavior across different platforms and terminal devices.

Accordingly, there is a need for an improved computer-implemented system in which a processor: (i) acquires and preprocesses training information to impart controlled attributes and value systems to a generative AI model; (ii) constructs prompt sentences that dynamically encode audiovisual context and role information; (iii) orchestrates multiple generative AI models or role settings in parallel to obtain multi-perspective responses; (iv) integrates emotion-state information from terminal devices or emotion-analysis mechanisms to adapt prompt content, model attributes, and response selection criteria; and (v) performs coordinated postprocessing and distribution-platform posting, so that responses can be generated and presented under relatively neutral and bias-reduced conditions with improved computational efficiency and system-level behavior.

The specific processing by the specific processing unit 290 of the data processing device 12 in Application Example 2 is realized by the following means.

The present invention provides a server comprising a processor configured to acquire training information related to a generative AI model from an information network or an information storage apparatus and perform preprocessing on the training information, train the generative AI model by using the preprocessed training information so that the generative AI model exhibits generation behavior based on specific attributes and value systems, construct a prompt sentence based on input information obtained from a user or on viewing information indicating audiovisual content being viewed by the user and dynamically determined contextual information or role information derived from content identification information and related information acquired from a distribution platform, input the prompt sentence into the generative AI model to cause the generative AI model to generate a natural language response, perform postprocessing on the natural language response including at least one of adjusting a length of the natural language response, removing inappropriate expressions, and correcting an emotional tone, transmit a postprocessed response as comment information to at least one of an audiovisual distribution platform and an information provision platform, generate a plurality of prompt sentences in parallel based on a plurality of generative AI models or a plurality of role settings corresponding to different viewpoints or different attributes, obtain a plurality of responses respectively from the plurality of prompt sentences and organize and output the plurality of responses in a list format so that the comment information or the responses are presented to a viewing terminal in association with the different viewpoints or the different attributes, adjust at least one of content of the prompt sentence, attributes of the generative AI model, and selection criteria for the responses based on emotional state information of the user acquired from at least one of a terminal apparatus and an emotion analysis mechanism so as to preferentially generate or select a response adapted to the emotional state of the user, and receive edited comment information transmitted from the terminal apparatus, associate the edited comment information with the comment information, and retransmit the edited comment information to the information provision platform. This enables the server to implement an integrated, processor-level control loop that coordinates training-data preprocessing, context-aware prompt sentence construction, multi-persona and emotion-adaptive response generation, structured postprocessing, and platform-level posting, thereby improving computational efficiency, reducing redundant model invocations, diminishing bias in presented responses, and enhancing the overall performance and robustness of the computer-implemented generative AI system.

The term “processor” refers to a hardware computation unit or a combination of hardware computation units, including but not limited to a central processing unit, a graphics processing unit, or a dedicated accelerator, that executes program instructions to perform the functions described in the present specification.

The term “generative AI model” refers to a machine-learned model configured to generate natural language text or other content in response to input data, including but not limited to neural network models that produce probabilistic sequences conditioned on prompt sentences.

The term “training information” refers to digital data, including but not limited to text, labels, and associated metadata, that is used as input for training or fine-tuning a generative AI model so as to influence its generation behavior.

The term “preprocessing” refers to a sequence of data-processing operations performed on training information prior to model training, including but not limited to cleaning, normalization, tokenization, formatting, and labeling, in order to place the information into a form suitable for input to a generative AI model.

The term “attributes and value systems” refers to abstract configuration properties associated with a generative AI model, including but not limited to attitude, tone, perspective, ideology, preference patterns, and other characteristic tendencies that influence how the model generates responses.

The term “generation behavior” refers to the operational characteristics of a generative AI model in producing output content, including but not limited to the style, tone, and semantic direction of the generated natural language in response to a given prompt sentence.

The term “prompt sentence” refers to input information, expressed as a natural language string or a structured representation, that instructs a generative AI model regarding the content, style, role, or constraints of a response to be generated.

The term “input information obtained from a user” refers to data provided directly or indirectly by a human operator, including but not limited to text queries, commands, feedback, and selections entered through an input device or a terminal apparatus.

The term “viewing information” refers to data indicating audiovisual content being consumed by a user, including but not limited to content identifiers, playback positions, metadata describing the content, and contextual usage information.

The term “audiovisual content” refers to digital media comprising at least one of visual information and audio information, including but not limited to video streams, recorded programs, live broadcasts, and multimedia presentations.

The term “content identification information” refers to data that uniquely or semi-uniquely identifies audiovisual content, including but not limited to content identifiers, resource locators, channel identifiers, or program identifiers issued by a distribution platform.

The term “related information” refers to auxiliary data associated with audiovisual content, including but not limited to titles, descriptions, tags, categories, statistics, and time-related markers obtained from a distribution platform or information source.

The term “distribution platform” refers to an information system or service that stores, manages, and delivers audiovisual content or other information to terminal devices over a communication network.

The term “contextual information” refers to data that characterizes a situation in which a generative AI model is invoked, including but not limited to content topics, user activities, temporal conditions, and environment-related parameters that influence construction of a prompt sentence.

The term “role information” refers to data that defines a behavioral role or persona for a generative AI model, including but not limited to indications of viewpoint, expertise, emotional tone, or narrative style that the model is to adopt when generating a response.

The term “natural language response” refers to text output generated by a generative AI model in a human language, such as a sentence or paragraph, which is interpretable by a human user as an answer, comment, explanation, or other linguistic expression.

The term “postprocessing” refers to processing operations applied to a natural language response after generation by a generative AI model, including but not limited to editing, filtering, normalization, formatting, and tone adjustment.

The term “comment information” refers to data representing a natural language response or an edited version thereof, which is intended to be posted, stored, or displayed as a comment, feedback, or annotation on a platform or terminal.

The term “audiovisual distribution platform” refers to a distribution platform specialized in handling audiovisual content, including but not limited to services that provide streaming, on-demand playback, or broadcast-like delivery of multimedia content.

The term “information provision platform” refers to an information system or service that supplies digital information to users, including but not limited to web services, application backends, social communication systems, and content management systems.

The term “plurality of generative AI models” refers to two or more generative AI models that are distinct in at least one aspect, including but not limited to training data, parameters, architectures, or assigned attributes and value systems.

The term “role settings” refers to configuration data that parametrically define one or more roles or personas for a generative AI model, including but not limited to system messages, constraints, or tags used when constructing prompt sentences.

The term “different viewpoints or different attributes” refers to distinct perspectives, stances, or model properties, including but not limited to optimistic, pessimistic, neutral, expert-oriented, or layperson-oriented orientations that lead to varied generated responses.

The term “list format” refers to an organized representation in which a plurality of responses are structured as an ordered or grouped collection, such as an array or list, that can be displayed or processed as multiple items associated with different viewpoints or attributes.

The term “viewing terminal” refers to an electronic device operated by a user for consuming audiovisual content or viewing information, including but not limited to a smartphone, tablet, personal computer, or display-equipped appliance.

The term “terminal apparatus” refers to a hardware device at an end point of a communication network used by a user to send input information, receive responses, and present data, including but not limited to mobile devices, desktop devices, and embedded devices.

The term “emotion analysis mechanism” refers to a computational component, implemented in hardware, software, or a combination thereof, that estimates a user's emotional state based on input signals such as text, audio, image, or interaction patterns.

The term “emotional state information” refers to data indicating an estimated emotion of a user, including but not limited to labels, scores, or vectors representing states such as joy, sadness, anger, fear, surprise, or combinations thereof.

The term “selection criteria for the responses” refers to rules, metrics, or algorithms used to choose one or more responses from among a plurality of generated responses, including but not limited to relevance, tone alignment, length, or emotion compatibility thresholds.

The term “edited comment information” refers to comment information that has been modified by a user or another process after an initial generation, including but not limited to additions, deletions, corrections, or rephrasings of original response content.

The term “information storage apparatus” refers to any hardware arrangement capable of storing digital information, including but not limited to nonvolatile memory devices, disk drives, network storage systems, and database servers.

The term “information network” refers to a communication infrastructure that interconnects computing resources and information sources, including but not limited to packet-switched networks, wired or wireless local-area networks, and wide-area networks such as the Internet.

In one or more embodiments, a server, a terminal, and a user cooperate to implement a system that trains and executes a generative AI model by using specific data structures, processing pipelines, and control logic, thereby improving the technical performance of computer-implemented natural language generation and content distribution.

A server includes at least one processor, a main memory, a nonvolatile storage apparatus, and a network interface. The processor may include a central processing unit, a graphics processing unit, or a dedicated accelerator. The main memory stores executable modules and data structures, and the nonvolatile storage apparatus stores training information, model parameters, persona configurations, and logs. The network interface connects the server to an information network.

A server uses general-purpose software components such as an operating system, a web application framework, and numerical computation libraries. For example, the server uses a web framework such as a Python-based framework to expose an HTTP application programming interface, a numerical computation library such as a tensor computation library or a deep learning library to build and train a neural network, a web scraping library such as an HTML parser to obtain raw textual content, a data manipulation library such as a table-oriented data library to preprocess the content, and a machine learning library such as a feature scaling toolkit to normalize auxiliary features.

A server configures a generative AI model as an autoregressive neural network, for example a Transformer-based sequence model with multiple encoder-decoder or decoder-only layers, multi-head self-attention units, position-wise feedforward networks, layer normalization, positional encodings, and learned token embeddings. The server stores model parameters as multi-dimensional tensors whose dimensions are sized according to vocabulary size, hidden size, and number of layers. The server initializes the generative AI model either from a pre-trained checkpoint or from random weights and then fine-tunes the model by using persona-specific datasets.

A server acquires training information from information sources accessible via an information network or from an information storage apparatus. The training information includes textual strings and associated metadata such as sentiment scores, topical tags, and persona labels. The server uses an HTML parser to extract plain text from markup documents, and the server uses a table-oriented data library to represent the extracted content as rows in a table, each row containing at least a text field, a source identifier, a timestamp, and a persona label.

A server performs preprocessing on the training information. The server normalizes text by lowercasing, removing markup tags, and replacing special characters according to a predefined mapping. The server segments the normalized text into tokens using a subword tokenizer such as a byte-pair encoding or a wordpiece tokenizer, and represents each token as an integer index. The server computes auxiliary features such as length, basic sentiment estimate, and topic category, and stores the features in additional columns of the table. The server applies a feature scaling toolkit to normalize numerical features to zero mean and unit variance. The server removes rows that do not satisfy quality thresholds, such as a minimum length or a maximum repetition ratio.

A server trains the generative AI model by using the preprocessed training information. The server forms training examples as sequences of token indices and uses a sliding-window or mini-batch strategy to feed sequences into the neural network. The server defines a loss function, such as a token-level cross-entropy error between predicted token distributions and ground-truth tokens. The server uses an optimization algorithm, such as an adaptive gradient method, to update model weights. The server computes gradients by back-propagation through the network graph and applies gradient clipping to prevent divergence. The server may perform data augmentation such as random masking, truncation, or persona prompt insertion into the training sequences, in order to improve robustness and persona distinction.

A server encodes specific attributes and value systems into the generative AI model by selecting training subsets and configuration signals. For example, the server uses a dataset biased toward positive sentiment, environmental themes, or analytical tone and includes persona tokens or persona-specific special symbols at the beginning of each training sequence. The server thereby trains the generative AI model so that, conditioned on a specific persona token, the model tends to generate responses consistent with that persona.

A server stores persona configurations in a database table. Each configuration includes a persona identifier, a short description, a role label, and prompt templates. For example, a persona configuration may contain a description such as “optimistic viewer,” a role label such as “Optimistic AI,” and a template such as “You are an optimistic viewer. From an optimistic perspective, answer the following question: {user_question}”. Another persona configuration may contain a description such as “pessimistic analyst” and a template such as “You are a pessimistic analyst. From a pessimistic perspective, answer the following question: {user_question}”.

A server constructs a prompt sentence for inference by combining user input, contextual information, and persona configuration. The server receives input information in the form of text entered by a user or viewing information indicating audiovisual content being viewed on a terminal. The viewing information includes at least a content identifier, playback time, title, and category. The server queries a distribution platform via a programming interface to obtain related information such as content description, tags, and audience statistics. The server optionally applies a natural language processing module to extract main entities and topics from the related information.

A server maps the viewing information and related information into contextual information and role information. For example, if the category indicates a movie review and the tags include genre information, the server sets a context field to “movie review, genre: drama” and selects a persona configuration appropriate for a viewer perspective. The server composes a prompt sentence that includes these fields. Example prompt sentences include:

“You are an optimistic viewer. You are watching a review of the movie ‘Inception’. At around 20 minutes, what is an impressive scene and how did it feel?”

“Based on this movie review video, what was the most impressive scene in the film? Answer as if you were a typical viewer.”

“Please provide optimistic, pessimistic, and neutral opinions about climate change from three different AI personas.”

“The user is angry about a product and wrote: ‘This product is totally useless!’. Generate a calm, empathetic reply that helps the user cool down.”

“The user is smiling while watching an environmental video. Generate an optimistic short news article about recent progress in environmental protection.”

A server tokenizes each prompt sentence, feeds the token indices into the generative AI model, and uses a decoding algorithm to produce output text. The server may use sampling strategies such as top-k sampling or top-p sampling to balance diversity and coherence. The server controls generation length by imposing a maximum step count or by detecting end-of-sequence symbols.

A server performs postprocessing on the generated natural language response. The server normalizes white-space, enforces a maximum number of characters or tokens, and uses pattern matching to remove or replace inappropriate expressions. The server may run a separate classifier or rule-based filter to detect prohibited terms or high-toxicity phrases and, when such content is detected, either discards the response or regenerates it with a modified prompt sentence that includes stricter instructions such as “Avoid offensive language and remain polite.”

A server transmits the postprocessed response as comment information to an audiovisual distribution platform or an information provision platform by using a platform-specific programming interface. The comment information is stored by the platform as a structured record associated with a content identifier and displayed in a comment section. Because the server enforces length, safety, and persona consistency at the processor level, a terminal can display the responses without additional heavy processing.

A terminal comprises a processor, a display unit, an input unit, a camera and audio capture unit, a memory, and a communication interface. The terminal runs an application that communicates with the server over a network. The terminal decodes audiovisual content streams from a distribution platform, obtains playback events, and reports viewing information to the server. The terminal provides user interface components for entering textual queries and viewing generated responses.

A terminal may capture user emotion by using the camera and audio capture unit. The terminal uses a computer vision library to detect a face and facial landmarks in video frames, extracts features such as eye openness and mouth curvature, and sends images or features to an external emotion analysis service. Alternatively, the terminal sends audio snippets to an audio-based emotion analysis service. The emotion analysis mechanism returns emotional state information, such as “joy” or “anger” with confidence scores. The terminal forwards the emotional state information to the server together with viewing information or user input.

A server adjusts content of the prompt sentence, attributes of the generative AI model, and selection criteria for responses based on the emotional state information. For example, if the emotional state is “anger,” the server selects a persona configuration that emphasizes empathy and de-escalation and incorporates instructions such as “Generate a calm, empathetic reply that helps the user cool down and offers help” into the prompt sentence. If the emotional state is “joy,” the server selects an optimistic persona and uses instructions such as “From an optimistic perspective, generate recent positive news about environmental protection.” This emotion-adaptive adjustment is not simply a label for display; it modifies the input tokens and persona tokens used as conditional context for the generative AI model, affecting the distribution over subsequent tokens and thus the generated text.

A server, in some embodiments, orchestrates a plurality of generative AI models or a plurality of role settings to obtain multi-perspective responses in a single coordinated operation. The server constructs multiple persona-specific prompt sentences from a single user question or viewing context and sends them to parallel inference workers, each associated with a persona token or a different generative AI model instance. The server collects the plural responses and organizes them into a list structure that associates each response with its persona label and metadata. By performing persona selection and parallelization at the server, the system reduces network round-trips, avoids redundant context computation on the terminal, and improves response latency for the user.

A terminal receives the list of responses from the server and renders them as separate items on the display unit, with labels such as “Optimistic view,” “Pessimistic view,” or “Neutral view.” The user may scroll through the list, compare content, and optionally select a response to edit. The terminal presents an editing interface where the user can modify text locally. After editing, the terminal transmits edited comment information back to the server. The server associates the edited comment information with the original comment information and posts it to the platform as user-authored content.

A server's integrated control loop yields technical effects that go beyond simple automation of human comment writing. The server reduces redundant invocations of the generative AI model by constructing context-rich prompt sentences that encode distribution-platform metadata and emotional state, thereby increasing the relevance of initial responses and reducing the need for repeated regeneration. The server decreases network load by aggregating multi-persona generation into single batched requests rather than separate user interactions. The server improves accuracy and consistency of persona behavior by using explicit persona tokens and persona-labeled training datasets instead of ad hoc style hints in free-form prompts. The server improves data management by storing prompt sentences, responses, emotional state information, and persona configuration in normalized database schemas, which facilitates traceability and quality control.

A server, by implementing a specific neural network architecture and training method, also improves internal computational performance. For example, the server selects sequence lengths, batch sizes, and attention implementations optimized for its hardware, and uses mixed-precision arithmetic on compatible processors to accelerate training and inference. The server uses caching of tokenized prompts and pre-computed key-value attention states when generating multiple responses for similar contexts, reducing repeated work and lowering latency for the terminal.

A server may implement alternative embodiments. In one embodiment, the server uses a single large generative AI model with persona tokens to represent all attributes and value systems. In another embodiment, the server maintains multiple smaller generative AI models, each fine-tuned for a specific persona or domain, and selects among them based on contextual information and emotional state information. In yet another embodiment, the server uses an ensemble approach, where outputs from several generative AI models are combined by a ranking or voting module that uses features such as relevance score, sentiment alignment, and length to select a final set of responses.

A server can also vary the emotion analysis mechanism. In one embodiment, the server directly invokes a text-based emotion classifier that shares part of the architecture with the generative AI model; the classifier reads user text and outputs an emotional state vector, which the server uses as additional conditioning input. In another embodiment, the server uses external services for image and audio emotion analysis and fuses their outputs by a rule-based engine or a small neural network, thus providing a more robust emotional state estimation.

A server may apply non-conventional, rule-based logic for prompt refinement and response selection. For instance, the server may maintain a rule table that, for each combination of content type, user emotion, and persona, defines specific phrases or constraints that must be included in the prompt sentence or avoided in the response. The server applies these rules systematically before and after calling the generative AI model. This rule-driven layer, combined with the probabilistic behavior of the model, creates a hybrid system that operates according to explicit, machine-implementable protocols that are not merely a digital replica of human editorial judgment.

Because the server implements these coordinated mechanisms at a low level training pipeline, model architecture, prompt construction, inference orchestration, emotion-adaptive control, and postprocessing the system as a whole exhibits reduced computation time for multi-persona response generation, improved alignment between generated content and user context, reduced error rate in terms of inappropriate or off-topic responses, and lower communication overhead between the server, terminal, and distribution platforms. These measurable improvements in speed, resource utilization, and output quality constitute improvements to computer technology itself, rather than mere automation of a human cognitive process.

A user operates the terminal to initiate various functions provided by the system. The user may start viewing audiovisual content on the terminal, type a question, or review AI-generated comments. The user may opt in to emotion-aware operation by permitting camera and microphone usage. The user may inspect multiple AI-generated viewpoints, edit selected responses, and post them. Through these interactions, the user indirectly triggers the described technical operations in the server and terminal, but the logic for data acquisition, model training, prompt sentence construction, inference orchestration, and postprocessing resides in the described computer system, enabling other implementers to reproduce the invention by configuring hardware and software according to the detailed embodiments.

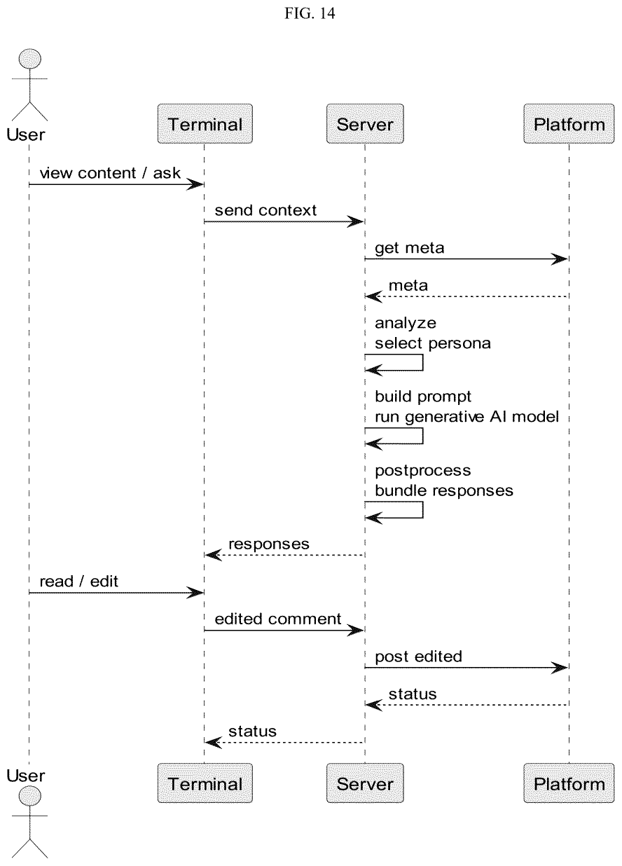

The following describes the processing flow using FIG. 14.

### Step 1

The terminal acquires user context and viewing information.

The terminal receives input from the user, such as a text question, a button press to request an AI comment, or playback events from an audiovisual player. The input includes at least a content identifier, current playback time, and basic metadata (for example, title and category) obtained from a player software development kit. The terminal processes this input by packaging it into a structured data object (for example, a record containing user ID, content ID, playback timestamp, and language). The output of this step is a context payload that the terminal transmits to the server over a network interface.

### Step 2

The server receives the context payload and enriches it with platform metadata.

The server receives the context payload from the terminal via an application programming interface endpoint. The input includes the content identifier, playback time, and basic metadata. The server uses the content identifier to query a distribution platform interface and acquires additional related information such as full title, description, tags, channel or provider information, and engagement statistics. The server processes these data by combining the received payload with the platform metadata into a normalized internal structure, for example a row in a database table with fields for topic, genre, and content type. The output is an enriched context record stored in memory and optionally persisted to storage.

### Step 3

The server analyzes text metadata and extracts semantic features.

The server uses the enriched context record as input, in particular the title, description, and tags. The server applies a natural language processing routine to segment the text, remove stopwords, and identify entities such as names of works, persons, or topics. The server computes features such as dominant topic, sentiment tendency, and key phrases. The server performs these computations by using tokenization, part-of-speech analysis, and frequency calculations. The output is a feature vector associated with the context record, containing fields such as topic label, sentiment label, and a list of extracted key terms.

### Step 4

The server selects a persona configuration based on context and system rules.

The server uses the feature vector and context record as input. The server consults a configuration database that defines multiple persona entries, each entry including a persona identifier, description, and associated conditions (for example, applicable content types or topics). The server performs rule evaluation by matching the topic label, sentiment tendency, or content category against these conditions. Based on this rule evaluation, the server selects one or more persona configurations, such as “optimistic viewer” or “pessimistic analyst.” The output is a list of persona configurations that will be used for constructing one or more prompt sentences.

### Step 5

The server constructs one or more prompt sentences for the generative AI model.

The server uses the selected persona configurations, the feature vector, and any user input text as input. For each persona configuration, the server retrieves a prompt template string that includes placeholders, such as “You are an optimistic viewer. You are watching a review of the movie ‘{movie_title}’. At around {time} minutes, what is an impressive scene and how did it feel?” The server performs a substitution operation, filling the placeholders with values from the context record (for example, movie title “Inception” and playback time “20”). When the user has entered a free-form question, the server inserts the question into a template such as “You are a pessimistic analyst. From a pessimistic perspective, answer the following question: {user_question}”. The output is one or more fully instantiated prompt sentences, each associated with a persona identifier.

### Step 6

The server optionally incorporates emotional state information into the prompt sentences.

The server receives emotional state information as input, for example a label such as “joy” or “anger” with confidence scores, transmitted from the terminal or from an emotion analysis mechanism. The server uses this information together with the persona configurations and context record. The server adjusts the prompt sentences by appending or integrating emotion-specific instructions, such as “The user is angry about a product and wrote: ‘This product is totally useless!’. Generate a calm, empathetic reply that helps the user cool down.” The server performs string concatenation or template selection based on the emotional label. The output is a set of emotion-aware prompt sentences that encode persona, context, and emotional state.

### Step 7

The server tokenizes the prompt sentences and prepares model input data.

The server uses the emotion-aware prompt sentences as input. The server applies a tokenizer that maps each character or subword unit to a numerical token ID according to a predefined vocabulary. The server constructs sequences of token IDs and, if persona tokens are used, the server prepends a special persona token ID at the beginning of each sequence to signal the desired persona behavior. The server pads or truncates the sequences to a fixed length suitable for the generative AI model. The output is a batch of integer sequences representing the prompt sentences, ready for input to the generative AI model.

### Step 8

The server executes the generative AI model to generate response token sequences.

The server uses the batch of token sequences as input. The server loads the generative AI model parameters into memory, including embedding matrices, attention weights, and feedforward weights. The server performs forward propagation: for each time step, the server computes embedded vectors, self-attention outputs, and feedforward transformations across the network layers. The server obtains probability distributions over the vocabulary for the next token. The server applies a decoding algorithm, such as top-k sampling or nucleus sampling, to select actual token IDs step by step, conditioned on previously generated tokens. The output is a set of generated token sequences, each sequence corresponding to a response for a given prompt sentence and persona.

### Step 9

The server converts the generated token sequences into natural language responses.

The server uses the generated token sequences as input. The server applies a detokenization process to map each token ID back to its corresponding text fragment and concatenates the fragments to form a response string. The server normalizes spacing and punctuation and removes any special control tokens (such as end-of-sequence markers). The output of this step is a list of natural language responses, each associated with its persona and context.

### Step 10

The server performs postprocessing on the natural language responses.

The server uses the list of responses and related metadata as input. The server enforces a maximum character or token length by truncating responses beyond a threshold. The server scans each response for patterns corresponding to prohibited terms or formats, using string search and pattern matching. The server optionally evaluates each response with a secondary classification model or a rule set to determine whether the response contains inappropriate content or an undesired emotional tone. If a response is flagged, the server either regenerates it with a revised prompt sentence (for example, adding “Avoid offensive language”) or discards it. The output is a set of filtered, length-controlled responses suitable for distribution.

### Step 11

The server aggregates multi-persona responses into a list structure.

The server takes the filtered responses and their associated persona identifiers as input. The server constructs a list or array data structure where each element includes fields such as persona label, short title (for example, “Optimistic view”), and response text. The server optionally orders the list based on a predefined rule or by evaluating simple metrics such as sentiment score or relevance. The server serializes this list into a structured representation for transmission. The output is a structured response bundle containing multi-perspective opinions.

### Step 12

The server transmits responses to the terminal and optionally posts comments to a platform.

The server uses the structured response bundle and, when appropriate, a selected response designated as a comment as input. For returning responses to the terminal, the server sends the bundle through the application programming interface as a response payload. For posting to a distribution platform, the server constructs a platform-specific request containing a content identifier and the selected response text. The server sends this request through the platform interface and receives a comment identifier in return. The output consists of a network response to the terminal containing the responses and, optionally, external comment identifiers.

### Step 13

The terminal receives the structured response bundle and displays the responses.

The terminal uses the network response from the server as input. The terminal parses the received structure to extract persona labels, titles, and response texts. The terminal updates its user interface, displaying each response in a separate visual item, such as a card or list row labeled with the persona designation. The terminal may highlight the persona and emotional context, for example marking “Optimistic view” or indicating that the reply is meant to calm anger. The output is a rendered user interface on the terminal display, where the user can read and compare the generated responses.

### Step 14

The user reviews, selects, and optionally edits a generated response.

The user interacts with the terminal interface as input to this step. The user selects one of the displayed responses and reads its content. If the user decides to edit the response, the user activates an edit function, which causes the terminal to populate an input field with the response text. The user makes changes such as adding personal opinions or removing parts and confirms the edit. The output from this step is edited text provided by the user and a selection indicating which original response was edited.

### Step 15

The terminal transmits the edited comment information to the server.

The terminal uses the edited text and the identifier of the original response as input. The terminal creates a message containing edited comment information, including fields for user ID, original response ID, and edited text. The terminal sends this message to the server via the application programming interface. The output is a network request that delivers the edited comment information to the server.

### Step 16

The server validates and associates the edited comment information.

The server receives the edited comment information as input. The server checks the edited text against validation rules similar to those used in postprocessing, such as length limits and prohibited phrase filters. If the text passes validation, the server stores the edited comment in an association table that links it to the original AI-generated response and to the user. The server then prepares a request to post the edited comment as user-authored content to the information provision platform or distribution platform. The output is a validated, associated edited comment record and, optionally, a platform posting request.

### Step 17

The server posts the edited comment to the platform and confirms status to the terminal.

The server uses the validated edited comment and platform identifiers as input. The server calls the platform interface with parameters including the content identifier and the edited comment text. The platform returns a success or error code and, when successful, a new comment identifier. The server records this identifier in its database and constructs a status message for the terminal, indicating success or failure. The output is a status response that the server sends to the terminal.

### Step 18

The terminal updates the user interface based on the posting status.

The terminal receives the status response from the server as input. If the status indicates success, the terminal updates the displayed comment list to show the edited comment as posted, and may indicate that it is now an official user comment. If the status indicates failure, the terminal may show an error message and allow the user to retry. The output is an updated visual state on the terminal that reflects the result of the platform posting operation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

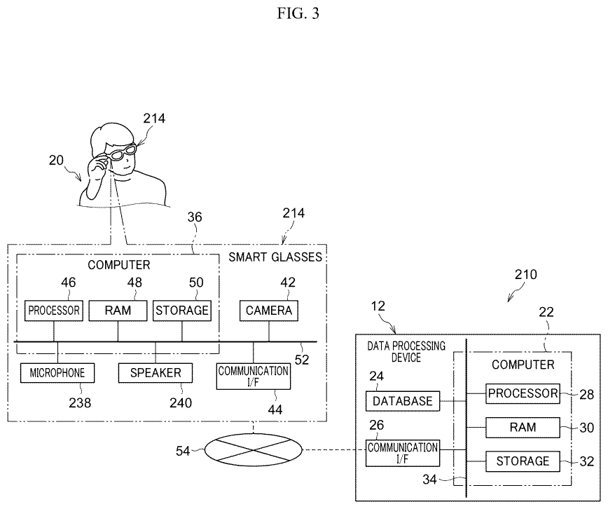

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

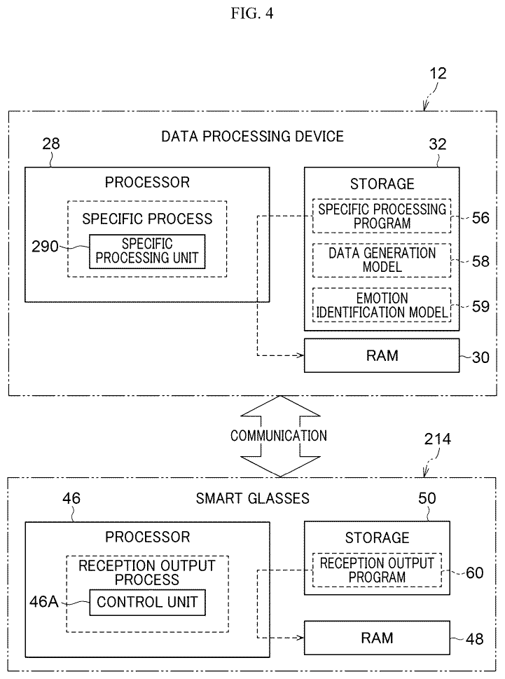

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

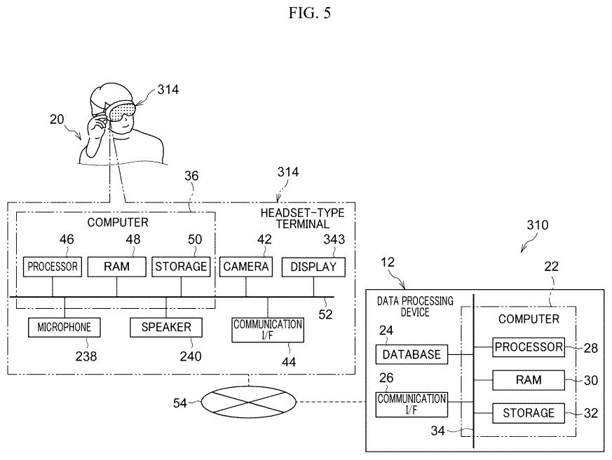

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

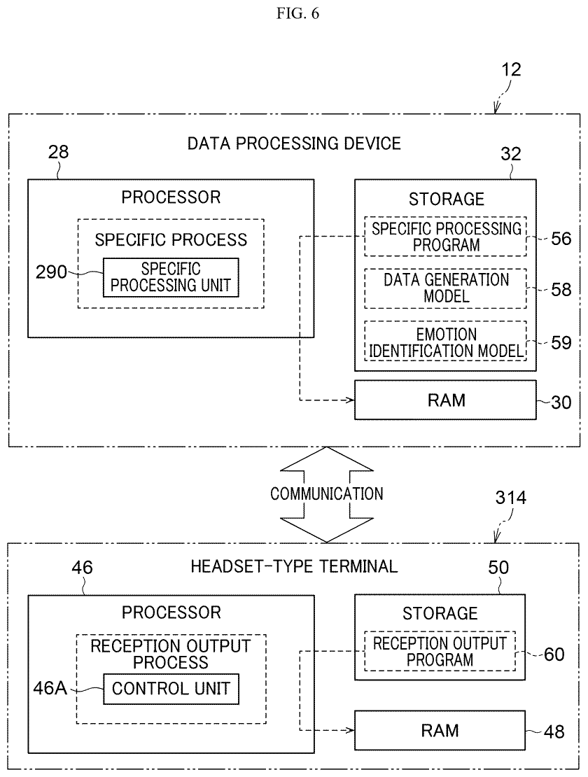

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

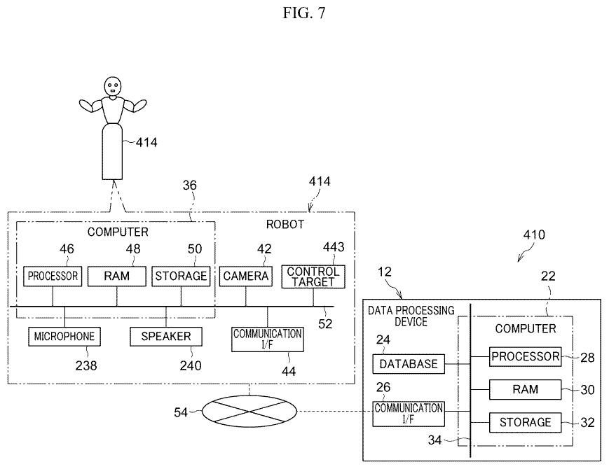

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

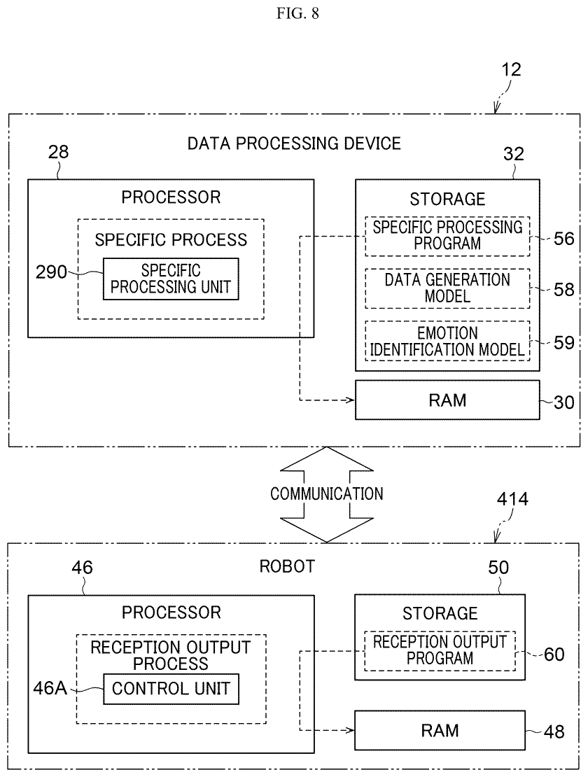

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

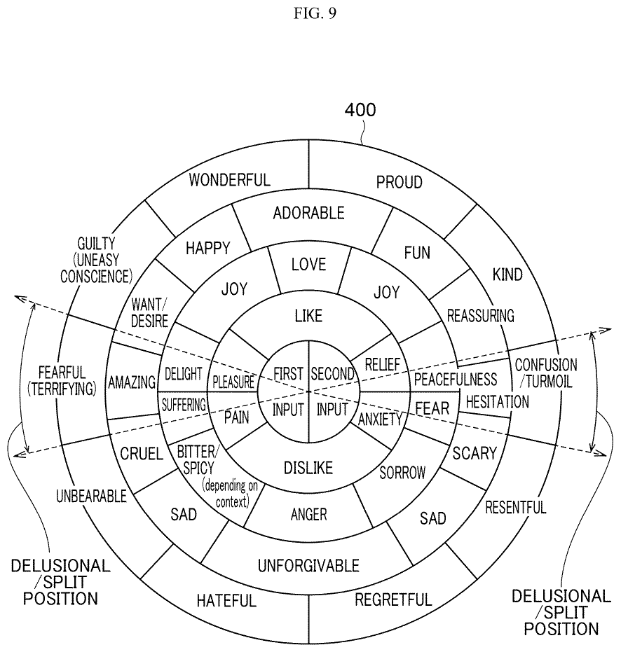

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

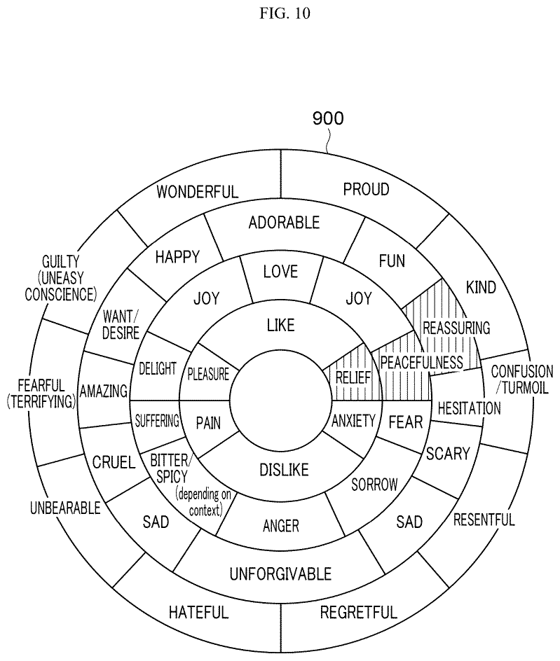

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire training information related to a predetermined attribute from an external information source in order to impart the predetermined attribute to a generative AI model, perform preprocessing on the training information including removal of unnecessary information and conversion into code sequences, and convert the preprocessed training information into a storage format,
execute a learning process of the generative AI model on an information processing terminal having computational resources, by using the preprocessed training information and an encoding unit corresponding to the generative AI model, and update an internal state of the generative AI model by performing backpropagation computation and optimization computation based on a loss function so as to generate an attribute-imparted generative AI model,
receive, for operating the attribute-imparted generative AI model, a prompt sentence as instruction information from a user, convert the prompt sentence into a code sequence by the encoding unit, input the code sequence into the generative AI model to cause the generative AI model to generate a sequential output code sequence, and restore the output code sequence into natural language information and output the natural language information as response information,
manage, for each attribute-imparted generative AI model, different training information and setting information in association with each other, acquire response information from a plurality of attribute-imparted generative AI models in accordance with the prompt sentence, and present the acquired response information as multifaceted response information, and in the learning process of the attribute-imparted generative AI model, use verification information to calculate a performance metric, and select and record the generative AI model that satisfies a predetermined condition as an operation model.

### Supplementary 2

The system according to supplementary 1,
wherein the processor is configured to
extract contents of the training information and characteristics of the response information in correspondence with the predetermined attribute imparted to the attribute-imparted generative AI model, and present an extraction result to the user as presentation information in a visible form so as to visualize the predetermined attribute in a manner understandable to the user.

### Supplementary 3

The system according to supplementary 1,
wherein the processor is configured to
reduce bias included in the response information by performing the learning process and output control processing such that weighting based on attribute information or external characteristics of an information source included in the training information is suppressed in generation of the response information by the attribute-imparted generative AI model.

### Application Example 1

### Supplementary 1

A system comprising a processor,
wherein the processor is configured to
store behavior information obtained from a user terminal in a storage device and estimate an interest attribute and a value attribute of a user on the basis of the behavior information,
store a plurality of types of role information associated with the interest attribute and the value attribute, generate a prompt sentence including the role information, advertising target information, and style condition information, and input the prompt sentence to a generative AI model to cause the generative AI model to generate advertising message information,
transmit the advertising message information to the user terminal and cause display control of the advertising message information on the user terminal,
acquire response information and opinion information of the user with respect to the advertising message information, update the interest attribute and the value attribute on the basis of the response information and the opinion information, and change content of the prompt sentence on the basis of the updated interest attribute and value attribute, and
use, as the generative AI model, a plurality of models having different role information or a single model to which different role information settings are applied, input the prompt sentence to each of the models to cause generation of a plurality of pieces of advertising message information, and select at least one of the plurality of pieces of advertising message information on the basis of a predetermined condition.

### Supplementary 2

The system according to supplementary 1,
wherein the processor is configured to
include, in generation of the prompt sentence, information defining a personality attribute and an ideology attribute of the generative AI model as the role information, and list the interest attribute, the value attribute, and the style condition information together with the role information so as to control the generative AI model to generate the advertising message information with a tone and a viewpoint that are easy for the user to understand.

### Supplementary 3

The system according to supplementary 1,
wherein the processor is configured to
acquire, as the response information and the opinion information, viewing operation information, selection operation information, purchase operation information, and free-text evaluation information related to the advertising message information, and analyze the viewing operation information, the selection operation information, the purchase operation information, and the free-text evaluation information by a machine learning process or a rule-based process so as to quantify and update the interest attribute and the value attribute.

### Example 2

### Supplementary 1

A system comprising a processor,
wherein the processor is configured to
receive, from a user terminal, a prompt sentence as an instruction for causing a generative AI model to generate information,
convert the received prompt sentence, based on the content of the prompt sentence, into a plurality of internal prompt sentences including an internal prompt sentence relating to a positive viewpoint, an internal prompt sentence relating to a negative viewpoint, and an internal prompt sentence relating to a neutral viewpoint, and construct each of the plurality of internal prompt sentences as input data for the generative AI model,
input the plurality of internal prompt sentences to the generative AI model and acquire, by deep learning processing performed by the generative AI model, a plurality of generated pieces of information corresponding respectively to the plurality of internal prompt sentences,
integrate the acquired plurality of generated pieces of information in a manner distinguishable by viewpoint and edit the integrated information as structured data to obtain integrated generated information that is multi-perspective and reduced in bias,
transmit the integrated generated information to the user terminal via a communication network and cause the user terminal to present the integrated generated information as a multi-viewpoint response, and
store information relating to the prompt sentence and the integrated generated information in association with identification information in a recording medium and accumulate the stored information as analysis data for subsequent control of the generative AI model.

### Supplementary 2

The system according to supplementary 1,
wherein the processor is configured to
analyze, for each of the plurality of generated pieces of information acquired in response to the plurality of internal prompt sentences, an evaluation direction and a content tendency indicated by each generated piece of information, and visualize an output tendency of the generative AI model in a format understandable to a user based on a result of the analysis.

### Supplementary 3

The system according to supplementary 1,
wherein the processor is configured to
perform information processing on the prompt sentence and the plurality of generated pieces of information to remove or reduce feature quantities dependent on individual speaker attributes or impressions of wording, thereby suppressing bias in evaluation in information generation by the generative AI model and providing, to the user terminal, the integrated generated information from a viewpoint independent of a speaking subject.

### Application Example 2

### Supplementary 1

A system comprising a processor,
wherein the processor is configured to
acquire training information related to a generative AI model from an information network or an information storage apparatus, the training information being used to impart specific attributes and value systems to the generative AI model, and perform preprocessing on the training information, the preprocessing including at least one of cleaning, normalizing, and labeling of the training information,
train the generative AI model by using the preprocessed training information so that the generative AI model exhibits generation behavior based on the specific attributes and value systems,
construct a prompt sentence, based on input information obtained from a user or on viewing information indicating audiovisual content being viewed by the user, the prompt sentence instructing the generative AI model to generate a predetermined natural language response, and input the prompt sentence into the generative AI model to cause the generative AI model to generate the natural language response,
analyze content of the audiovisual content by using content identification information and related information acquired from a distribution platform, and dynamically determine contextual information or role information to be included in the prompt sentence according to a result of the analysis,
perform postprocessing on the natural language response output from the generative AI model, the postprocessing including at least one of adjusting a length of the natural language response, removing inappropriate expressions, and correcting an emotional tone, and transmit a postprocessed response as comment information to at least one of an audiovisual distribution platform and an information provision platform,
generate a plurality of prompt sentences in parallel based on a plurality of generative AI models or a plurality of role settings corresponding to different viewpoints or different attributes, obtain a plurality of responses respectively from the plurality of prompt sentences, and organize and output the plurality of responses in a list format so that the comment information or the responses are presented to a viewing terminal in association with the different viewpoints or the different attributes,
adjust at least one of content of the prompt sentence, attributes of the generative AI model, and selection criteria for the responses, based on emotional state information of the user acquired from at least one of a terminal apparatus and an emotion analysis mechanism, and preferentially generate or select a response adapted to the emotional state of the user, and
receive edited comment information transmitted from the terminal apparatus, associate the edited comment information with the comment information, and retransmit the edited comment information to the information provision platform.

### Supplementary 2

The system according to supplementary 1,
wherein the processor is configured to
output, to the terminal apparatus as visual display information, information indicating the attributes and value systems of the generative AI model and a correspondence among the prompt sentence, the input information, and the response, thereby enabling the user to visually compare differences among a plurality of viewpoints.

### Supplementary 3

The system according to supplementary 1,
wherein the processor is configured to
control at least one of generation of the prompt sentence and the postprocessing so that bias based on at least one of social evaluation of a human speaker, decorative characteristics of a statement, and external evaluation indices is reduced, and the plurality of responses are presented under relatively neutral conditions by using the generative AI model as a non-human speaking entity.

What is claimed is:

1. A system comprising:
circuitry configured to:
acquire, from an external information source via a packet-switched network, data records associated with a predetermined attribute specification, each data record comprising a text field and a source identifier;
preprocess the acquired data records by removing non-semantic tokens and normalizing character representations to generate cleaned text sequences, and convert the cleaned text sequences into code sequences by applying a tokenizer that maps character substrings to integer identifiers according to a stored vocabulary data structure;
transmit, as data packets via the packet-switched network, the code sequences together with configuration parameters specifying a model architecture definition, optimization parameters, and an attribute identifier, to an information processing node having computational resources;
receive, from the information processing node, parameter data representing an attribute-imparted generative information processing model whose internal state has been adjusted by a learning process comprising forward computation, gradient computation, and optimization computation applied to the code sequences;
evaluate the attribute-imparted generative information processing model by computing a performance metric using verification data distinct from the code sequences, compare the performance metric against a predetermined threshold, and upon the performance metric satisfying the predetermined threshold, register the attribute-imparted generative information processing model as an operation model in an information storage structure; and
in response to receiving an input instruction sequence from a terminal device, encode the input instruction sequence into an input code sequence, input the input code sequence into the registered operation model, obtain an output code sequence by sequential token generation, decode the output code sequence into response data, and transmit the response data as data packets via the packet-switched network to the terminal device.

2. The system according to claim 1, wherein the circuitry is configured to store, in the information storage structure, a plurality of attribute-imparted generative information processing models each associated with a different attribute identifier, and in response to the input instruction sequence, select two or more of the plurality of attribute-imparted generative information processing models, generate respective output code sequences from each selected model, and integrate the respective decoded response data into a multifaceted output data structure in which each response data item is associated with its corresponding attribute identifier.

3. The system according to claim 2, wherein the circuitry is configured to present the multifaceted output data structure to the terminal device with each response data item displayed in association with a label indicating the corresponding attribute identifier, and to receive selection data from the terminal device indicating a preferred response data item.

4. The system according to claim 3, wherein the circuitry is configured to convert the input instruction sequence into a plurality of internal instruction sequences each associated with a respective viewpoint designation comprising at least a positive viewpoint, a negative viewpoint, and a neutral viewpoint, input each internal instruction sequence to the generative information processing model, and structure the resulting output data items in a format distinguishable by viewpoint designation.

5. The system according to claim 1, wherein the circuitry is configured to suppress weighting based on source-specific attribute data in the data records during preprocessing by removing metadata fields indicating source identity, popularity indicators, and external reputation data from the data records prior to conversion into code sequences.

6. The system according to claim 5, wherein the circuitry is configured to adjust a sampling distribution during the learning process to reduce over-representation of data records from frequently occurring sources, the sampling distribution being defined by a weighting vector that assigns an inverse-frequency coefficient to each source identifier.

7. The system according to claim 6, wherein the circuitry is configured to perform postprocessing on the response data comprising at least one of adjusting a length parameter, filtering expressions matching a prohibited pattern list, and modifying an emotional tone parameter based on a tone specification included in the input instruction sequence.

8. The system according to claim 1, wherein the circuitry is configured to store, in a storage device, behavior data obtained from the terminal device comprising at least one of viewing event data, selection event data, and temporal usage pattern data, and to compute from the behavior data an interest attribute vector and a value attribute vector for a user associated with the terminal device.

9. The system according to claim 8, wherein the circuitry is configured to associate, in the information storage structure, a plurality of role definitions each comprising a personality parameter, an ideology parameter, and a tone parameter, with respective ranges of interest attribute values and value attribute values, and to select a role definition whose associated ranges correspond to the computed interest attribute vector and value attribute vector of the user.

10. The system according to claim 9, wherein the circuitry is configured to construct the input instruction sequence by embedding the selected role definition, target content information, and style condition parameters into a prompt template, and to input the constructed input instruction sequence to the attribute-imparted generative information processing model to generate content data adapted to the user.

11. The system according to claim 10, wherein the circuitry is configured to acquire response event data and opinion data from the terminal device with respect to the generated content data, update the interest attribute vector and the value attribute vector based on the acquired response event data and opinion data, and modify a subsequent input instruction sequence based on the updated interest attribute vector and value attribute vector.

12. The system according to claim 1, wherein the generative information processing model comprises a transformer architecture having an embedding layer, a plurality of self-attention layers, a plurality of feed-forward layers, and an output projection layer that maps internal state vectors to token probability distributions.

13. The system according to claim 12, wherein the circuitry is configured to generate the output code sequence by applying an autoregressive decoding strategy comprising at least one of greedy decoding, beam search, and stochastic sampling with a temperature parameter, and terminating generation upon reaching a predetermined length limit or an end-of-sequence token.

14. The system according to claim 1, wherein the learning process further comprises learning-rate warmup over an initial subset of training iterations, gradient clipping at a predetermined maximum gradient norm, and weight decay regularization applied to the optimization computation.

15. The system according to claim 1, wherein the circuitry is configured to store the input instruction sequence and the response data in association with an identification tag as analysis data in the information storage structure, and to compute, from accumulated analysis data, a statistical distribution of output tendencies across attribute identifiers, and to generate visualization data representing the statistical distribution for display on the terminal device.

16. The system according to claim 15, wherein the circuitry is configured to construct the input instruction sequence based on viewing information indicating audiovisual content being consumed on the terminal device, and to determine contextual parameters and role parameters for inclusion in the input instruction sequence based on content identification data and metadata acquired from a distribution platform.

17. The system according to claim 16, wherein the circuitry is configured to adjust at least one of the input instruction sequence content, the attribute identifier selection, and a response selection criterion based on emotional state data of the user acquired from the terminal device or an emotion analysis module, and to preferentially select a response data item adapted to the emotional state of the user.

18. A system comprising:
circuitry configured to:
acquire data records associated with an attribute specification from an external information source, preprocess the data records by removing non-semantic tokens and normalizing character representations, and convert the preprocessed data records into code sequences using a tokenizer;
transmit the code sequences and configuration parameters to an information processing node, and receive from the information processing node parameter data representing an attribute-imparted generative information processing model trained by a learning process applied to the code sequences;
evaluate the attribute-imparted generative information processing model using verification data, and register the model as an operation model upon a performance metric satisfying a predetermined threshold;
in response to an input instruction sequence, generate response data by encoding the input instruction sequence, inputting the encoded sequence to the operation model, and decoding an output code sequence;
store, in an information storage structure, a plurality of operation models each associated with a different attribute identifier, and generate multifaceted response data by obtaining output from a plurality of operation models for a common input instruction sequence;
compute, from behavior data obtained from a terminal device, interest and value attribute vectors for a user, select a role definition based on the attribute vectors, and incorporate the role definition into the input instruction sequence; and
transmit the response data as data packets via a packet-switched network to the terminal device.

19. The system according to claim 18, wherein the circuitry is configured to convert a single input instruction sequence into a plurality of internal instruction sequences each associated with a different viewpoint designation, obtain respective response data items from the generative information processing model for each internal instruction sequence, and integrate the response data items into a structured output distinguishable by viewpoint designation.

20. A method performed by circuitry of a system, the method comprising:
acquiring, from an external information source via a packet-switched network, data records associated with a predetermined attribute specification;
preprocessing the acquired data records by removing non-semantic tokens and normalizing character representations to generate cleaned text sequences, and converting the cleaned text sequences into code sequences using a tokenizer;
transmitting the code sequences and configuration parameters to an information processing node, and receiving parameter data representing an attribute-imparted generative information processing model trained by a learning process applied to the code sequences;
evaluating the attribute-imparted generative information processing model by computing a performance metric using verification data, and registering the model as an operation model upon the performance metric satisfying a predetermined threshold; and
in response to receiving an input instruction sequence from a terminal device, encoding the input instruction sequence, inputting it to the operation model, decoding an output code sequence into response data, and transmitting the response data as data packets via the packet-switched network to the terminal device.
